(19) United States
(12) Patent Application Publication
(10) Pub. No.: US 2002/0103680 A1
(43) Pub. Date: Aug. 1, 2002

(54) Systems, methods and computer program products for managing employee benefits

(76) Inventor: Les A. Newman, Cuyahoga Falls, OH (US)

Correspondence Address: HAHN LOESER & PARKS, LLP, TWIN OAKS ESTATE, 1225 W. MARKET STREET, AKRON, OH, 44313, US

(21) Appl. No.: 10/061,971

(22) Filed: Jan. 31, 2002

Related U.S. Application Data
(63) Continuation-in-part of application No. 09/726,869, filed on Nov. 30, 2000.
(60) Provisional application No. 60/265,859, filed on Feb. 1, 2001.

(51) Int. Cl. G06F 17/60

(52) U.S. Cl. 705/4

(57) ABSTRACT

A system, method and computer program product for managing the provision and administration of employee benefits is herein provided. The system, method and computer program product of the present invention electronically accepts and stores data related to employee benefits and allows users to alter that data according to desired parameters. The system, method and computer program product also includes a communication function that enables electronic employee benefit data to be transmitted among modules of the data processing system or computer program product and also among various users of the invention.

This application claims the benefit of U.S. Provisional Application No. 60/265,859. This application is a continuation-in-part of co-pending application number 09/726,869 filed on Nov. 30, 2000.

### TECHNICAL FIELD

The present invention relates generally to systems, methods, and computer program products for managing the provision and administration of employee benefits.

### BACKGROUND

To provide cost effective health care to employers and employees a number of health care networks have been created. Networks are extremely important in controlling health care costs in today's managed health care environment. Typical health insurance plans consist of approximately 10% administrative expenses and 90% claim costs. The networks and the discounts associated with the networks impact on the cost of the health insurance programs because 90% of the cost consists of the claims, which are discounted by the networks.

A ‘network’ is defined as a contractual relationship between a party or company and providers of medical services. The party or company then offers services to employers and/or employees through the network. Providers are defined as doctors, hospitals and medical service providers. Under the contractual relationship, doctors and hospitals enter into relationships with networks to provide a reduction in their fees for services to members of the network. In exchange for the reduction in fees the doctor or hospital receives a larger volume of patients referred to it by the network. In exchange for patient volume, doctors and hospitals contract with networks on a reduced fee basis.

Networks can be divided into two basic categories, proprietary networks and independent networks. Proprietary networks are networks owned by insurance companies or third party administrators. Independent networks are individuals or corporations who have directly contracted with doctors and hospitals to form their own network. Independent networks rent their networks out to payers of claims such as insurance companies or third party administrators.

Networks can be further classified based on how they contract with doctors and hospitals. Depending on the contracting practice, networks are either steered networks or non-steered networks. Steerage in a benefit program refers to whether there are benefit differences for in-network versus out-of-network benefits. For example, if an employee belongs to a network that is a steered network, and the employee then goes to an in-network doctor or hospital, the employee will receive a higher benefit reimbursement than if the same employee went to a doctor or hospital not in the network. Some contracts between doctors, hospitals and the network require that steerage be in place, i.e., that employees be provided a cost incentive to see doctors and go to hospitals that are part of the network. Other contracts do not require steerage.

Historically, managed health care and benefit organizations have not been particularly concerned with which doctors and hospitals employees' use. Insurance companies or the payer of the claims typically offer a higher benefit amount to employees who use particular doctors and hospitals. The employee can use doctors and hospitals not specifically approved by the insurance company or payer but will receive a lower benefit. In other words, the employee will have to pay more out of his or her own pocket unless specified doctors and hospitals are used. The employees have a choice; they will either go for the higher benefits and switch doctors if their doctor isn't in the network already or they will just receive a lower benefit. The problem with this approach has always been an adverse reaction on the part of the employees, which causes disruption or problems for the employer in the satisfaction and moral of its workforce.

Another problem with networks has been the level of analysis available to customers when determining whether to subscribe to the networks' services. The prior art consists of such methods as geoaccess reports. These are used when a network is trying to sell its services to an employer or a given employer group. The geoaccess report will determine how many doctors or hospitals are within a specific mile radius of each employee based upon the employees' zip code. This type of information has little true value as it is immaterial to the employer, and more particularly to the employee, how many doctors or hospitals are within two, three or four miles of their residence. An important criterion from the employee's perspective, and therefore the employer's perspective, is whether the new network includes a doctor that the employee uses. If the network doesn't include a doctor or hospital normally used by the employee he or she will be disrupted and unhappy. Another drawback in the prior art is that there is no review of the specific claims a particular group has against the discounts and what discounts would be generated on that claim set by the various networks in the marketplace. The marketplace does not measure how much cost savings can be brought to bear by the selection of different networks nor has any measurement of the group's level of discounts been done.

The prior art is also deficient with regard to forecasting the effect of changes in an employer's group health insurance benefit plan. There are primitive forecaster or modeling tools in the prior art that allow users to view the effects caused by changes in a few benefit parameters. The prior art forecasters also can operate based upon an actuarial database or formula. The result from using an actuarial formula is, for example, what an employer can expect if the employee's deductible is changed from a $100 to $200. The percentage of reduced costs is a statistic that actuaries have developed based upon an examination of large group numbers. In general, prior art forecasters or modeling tools do not provide sufficient detail necessary for maximizing health care savings td employers and employees. Finally, the prior art is deficient in providing an accurate method of examining and comparing an employee group's health care usage pattern with actuarial normative information.

For reasons generally outlined above, it would be highly desirable to have systems, methods and computer program products that would be able to analyze employee benefits based on detailed claim records, determine the level of discounts or the effective rate of discounts provided by various health care networks, generate health care and benefits usage pattern information for employees and their family members, perform disruption analysis to employees and their families caused by switching health care networks, forecast the effects of changes to group health insurance benefits plans, and compare actual usage of health care services by employees and their families against actuarial normative information to determine endemic usage patterns.

Therefore, in light of the foregoing deficiencies in the prior art, the applicant's invention is herein presented.

### SUMMARY

The present invention relates to systems, methods and computer program products used for analyzing, modeling a variety of types of employee benefits. The present system deals with examining the attributes of employee benefit programs, actual claims of employees, and the effect of changes to employee benefit programs. The present invention provides a system, method and computer program product to simplify various processes associated with employee benefits. The present invention is described as being divided into various modules which can act independently or interface with other modules when necessary. The various features the employee benefits field which are addressed by the present invention are plan design modeling, consortiums, renewal rate calculators, settlement calculators, data element extraction, disease management, requests for quotations, administrative services, prescription benefit management, prescription benefit management audit, employee benefit statements, fraud detection, and billing.

It is an object of the present invention to automate some of these processes and make the processes more easily accessible to employers and employees.

Another object of the present invention is to expedite the insurance underwriting process and provide data necessary for underwriting in an easily usable format for both employers and underwriters.

An advantage of the present invention is that a substantial amount of information and tools related to employee benefit processes will be consolidated into a single source.

Another advantage of the present system is that the various modules and tools of the present invention are integrated such that data used in one tool can be imported to another module, extracted to another module, or one or more modules can be combined to perform multiple operations on the same data.

These features and advantages of the present invention will be described and explained more fully below.

### BRIEF DESCRIPTION OF THE DRAWINGS

FIGS. 1A-3B are flow charts schematically illustrating operations for the Network Modeling method and apparatus, according to the present invention;

FIGS. 4A-4O are output reports for multiple types of employee benefits analysis, according to the present invention;

FIGS. 5A-5B are flow charts schematically illustrating operations for the Plan Design Modeling method and apparatus, according to the present invention;

FIGS. 6A-6G are screen displays for the Plan Design Modeling method and apparatus, according to the present invention; and

FIG. 7 is a flow chart schematically illustrating operations for the Group Health Caims Analysis method and apparatus, according to the present invention.

FIG. 8A is a schematic depiction of consortiums in the present invention.

FIG. 8B illustrates plan design modeling in a consortium.

FIG. 9 is a second schematic depiction of consortiums in the present invention.

FIG. 10 is a flow chart showing an insurance settlement calculation in the present invention.

FIG. 11 is a flowchart showing data element extraction of the present invention.

FIG. 12 is a schematic depiction of a disease management system of the present invention.

FIG. 13 illustrates the administrative services module of the present invention.

FIG. 14 is a flow chart showing an embodiment of the fraud detection service of the present invention.

### DETAILED DESCRIPTION OF THE INVENTION

The present invention is fully described hereinafter with reference to the drawings, in which preferred embodiments of the invention are shown. The invention may also be embodied in many different forms and should not be construed as limited to only the disclosed embodiments. The provided embodiments are included so the disclosure will be thorough, complete and will fully convey the scope of the invention to persons of ordinary skill in the art.

A person of ordinary skill in the art would appreciate that the present invention may be embodied as a method, data processing system, or computer program product. As such, the present invention may take the form of an embodiment comprised entirely of hardware; an embodiment comprised entirely of software or an embodiment combining software and hardware aspects. In addition, the present invention may take the form of a computer program product on a computer-readable storage medium having computer-readable program code means embodied in the medium. Any suitable computer readable medium may be utilized including hard disks, CD-ROMs, optical storage devices, or magnetic storage devices.

The present invention is described with reference to flowcharts and/or diagrams that illustrate methods, apparatus or systems and computer program product. It should be understood that each block of the various flowcharts, and combinations of blocks in the flowcharts, can be implemented by computer program instructions. Such computer program instructions can be loaded onto a general-purpose computer, special purpose computer, or other programmable data processing device to produce a machine, such that the instructions that execute on the computer or other programmable data processing apparatus create means for implementing the functions specified in the flowcharts. The computer program instructions can also be stored in a computer-readable memory that directs a computer or other programmable data processing device to function in a particular manner, such that the instructions stored in the computer-readable memory produce an article of manufacture including instruction means which implement the function specified in the flowcharts or diagrams. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowcharts or diagrams.

It will be understood that blocks of the flowcharts support combinations of means for performing the specified functions, combinations of steps for performing the specified functions and program instruction means for performing the specified functions. It is also to be understood that each block of the flowcharts or diagrams, and combinations of blocks in the flowcharts or diagrams, can be implemented by special purpose hardware-based computer systems which perform the specified functions or steps, or combinations of special purpose hardware and computer instructions.

The present invention could be written in a number of computer languages including, but not limited to, C++, Basic, Visual Basic, Fortran, COBOL, Smalltalk, Java, and other conventional programming languages. It is to be understood that various computers and/or processors may be used to carry out the present invention without being limited to those described herein. The present invention can be operated or run on a computer such as an IBM or IBM-compatible personal computer, preferably utilizing a DOS, Windows 3.1, Windows 95, Windows NT, Windows 2000 or higher, Unix, OS/2, or other operating system. However, it should be understood that the present invention could be implemented using other computers and/or processors, including, but not limited to, mainframe computers and mini-computers.

The present invention consists of three computer program or software modules, each of which performs a different analysis or function related to employer/employee health insurance related benefits. The three computer program modules interact with one another to provide a full range of functions. Each computer program module can also be run or operated individually depending upon the desired function. In addition to health insurance or medical insurance benefits, the computer program modules of the present invention can be configured to include additional employee benefits such as dental coverage, vision coverage, and other benefits normally included in an employer benefits package provided to employees. In addition, the analysis performed by the computer program modules of the present invention are equally applicable to the same or similar “benefits” provided through Workers Compensation programs. The applicant therefore contemplates using the present invention to perform the same and/or similar modeling and analysis of Workers Compensation benefits.

The first computer program module is the Network Modeling module. Network Modeling is fundamentally a tool for analyzing employee benefits by viewing detailed claim records of groups of one hundred or more employees and groups that are self-funded. Self-funded groups refer to those groups that are self-insured under an ERISA contract as opposed to a fully insured premium payment basis with an insurance company. ERISA is an acronym for the Employee Retirement Income Security Act that governs the funding, vesting, administration, and termination of private pension and other health and welfare plans. On employee groups of fewer than one hundred lives or fully insured groups under one hundred lives, Network Modeling requires an examination of survey data completed on the part of employees. The primary difference between the groups of 100 or more lives and those under 100 lives is the detailed review of individual claim records on the 100+ groups versus a review of survey information on the doctors and hospitals compiled from completed survey forms from employees.

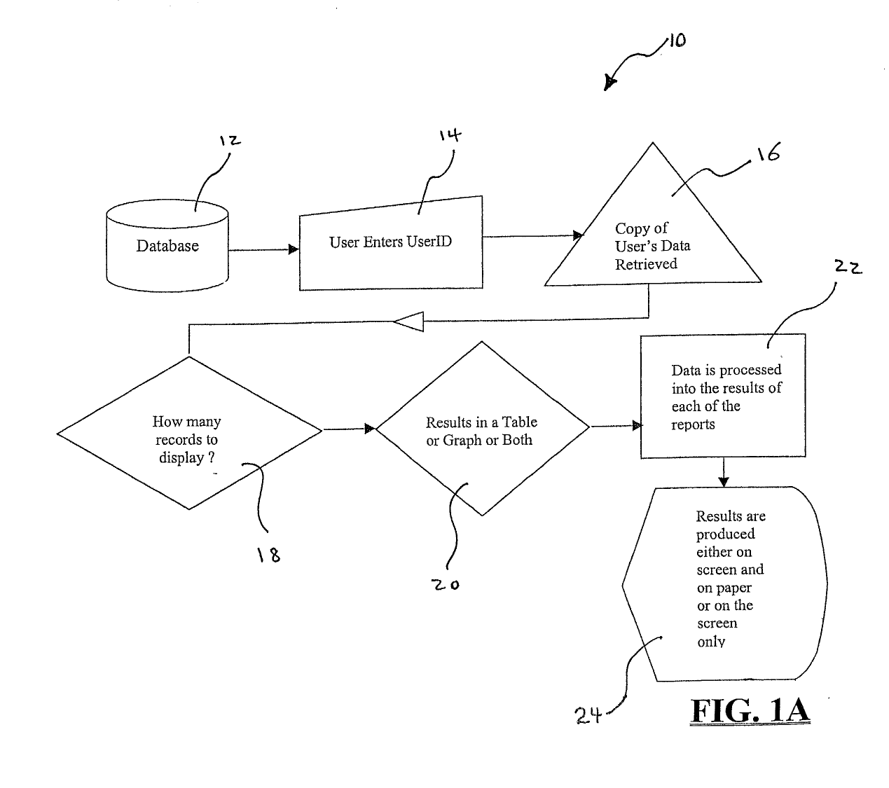

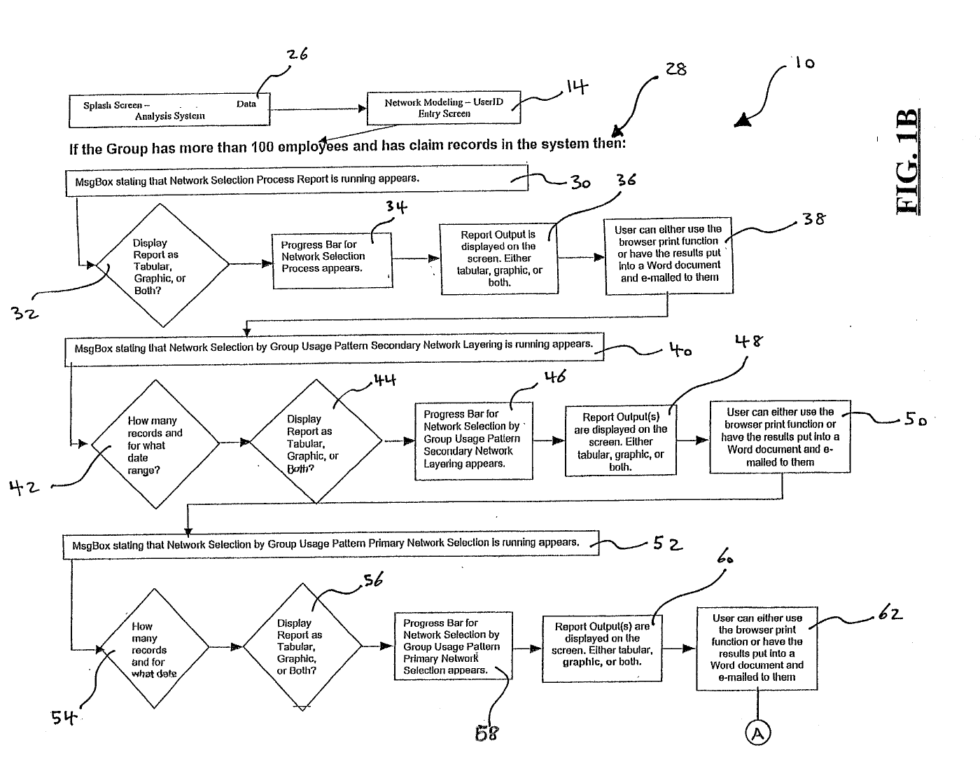

Referring to FIGS. 1A-1C, the Network Modeling module 10 will be described in more detail. Referring specifically to FIG. 1A, the work flow for Network Modeling module 10 begins with benefit Claim Data records being imported from files received from insurance companies. In a preferred embodiment, the Claim Data record files are stored on tables in database 12 in SQL Server 7.0 on a Windows NT or higher server. A customer (not shown) accesses the Network Modeling (along with the other modules described later) via the Internet. The customer enters a user identification code 14 which provides security for the customer's information. Once the customer accesses the computer system, the computer program retrieves information that pertains to that particular employer group 16. The customer is then prompted to select the number of records to be displayed, printed or otherwise retrieved 18. The customer has numerous choices at this point, which will be described in more detail later. Next, the customer is prompted to select how the information should be displayed, printed or otherwise output 20. In the preferred embodiment, information can be displayed and/or formatted in a tabular format, a graphical format or both. Once the information is processed 22 it can either be displayed on the computer display screen, printed out on paper or both 24. In one embodiment, the calculated information is not stored in any of the database tables. If the customer wishes to keep the information, it must be printed or the calculations must be run again. Although the information is not stored to conserve computer memory space, one of ordinary skill in the art would understand that additional memory is all that is needed to store the reports. Storage of reports is contemplated as a feature of the present invention by the applicant.

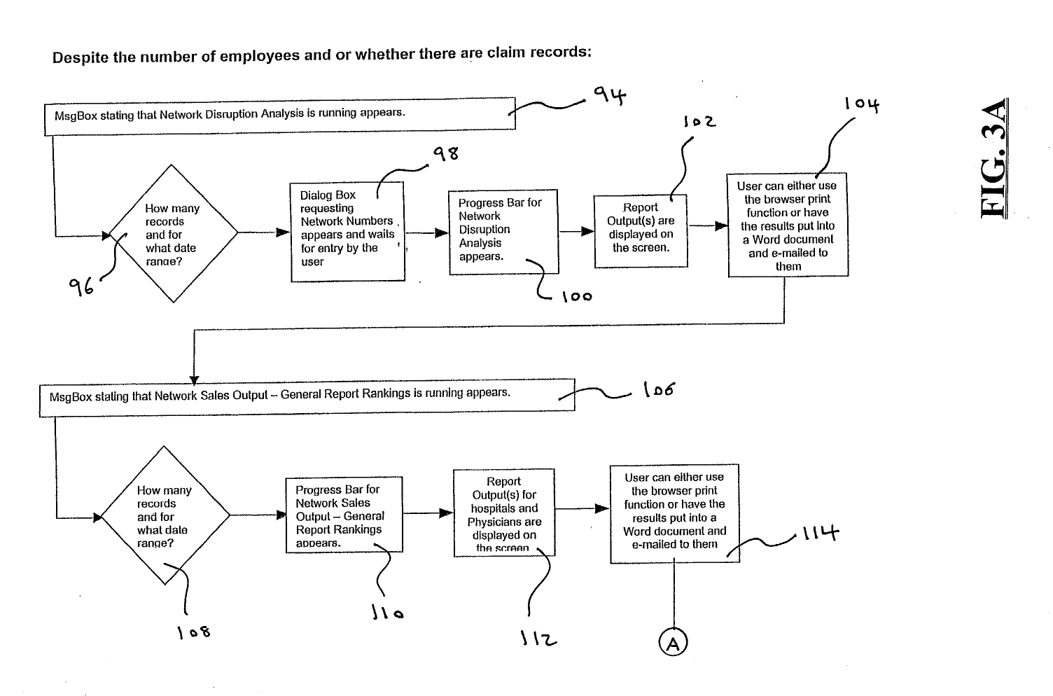

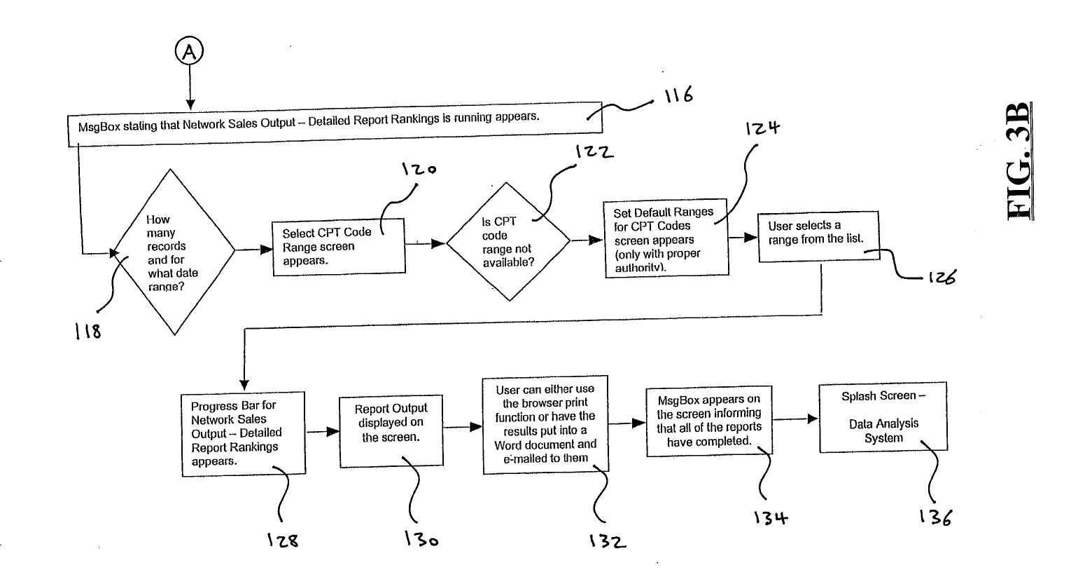

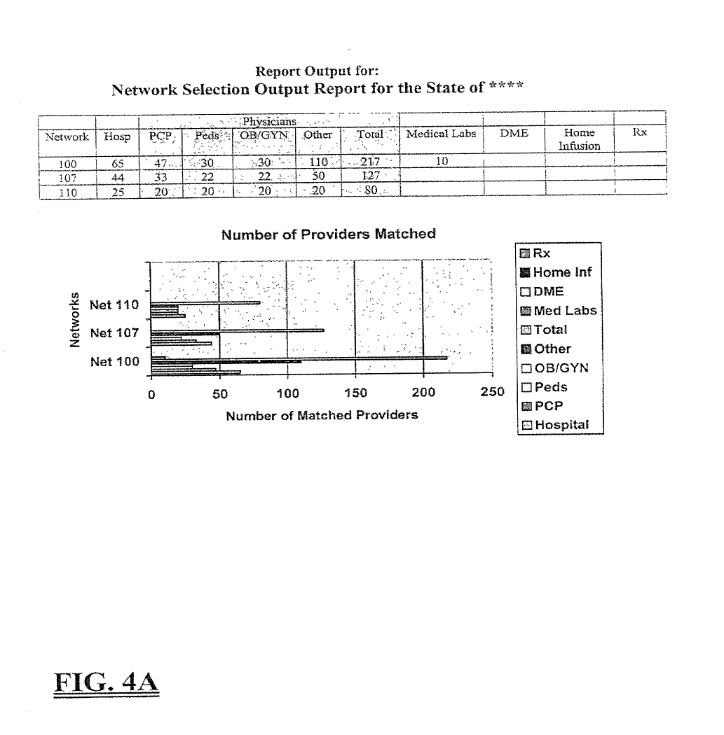

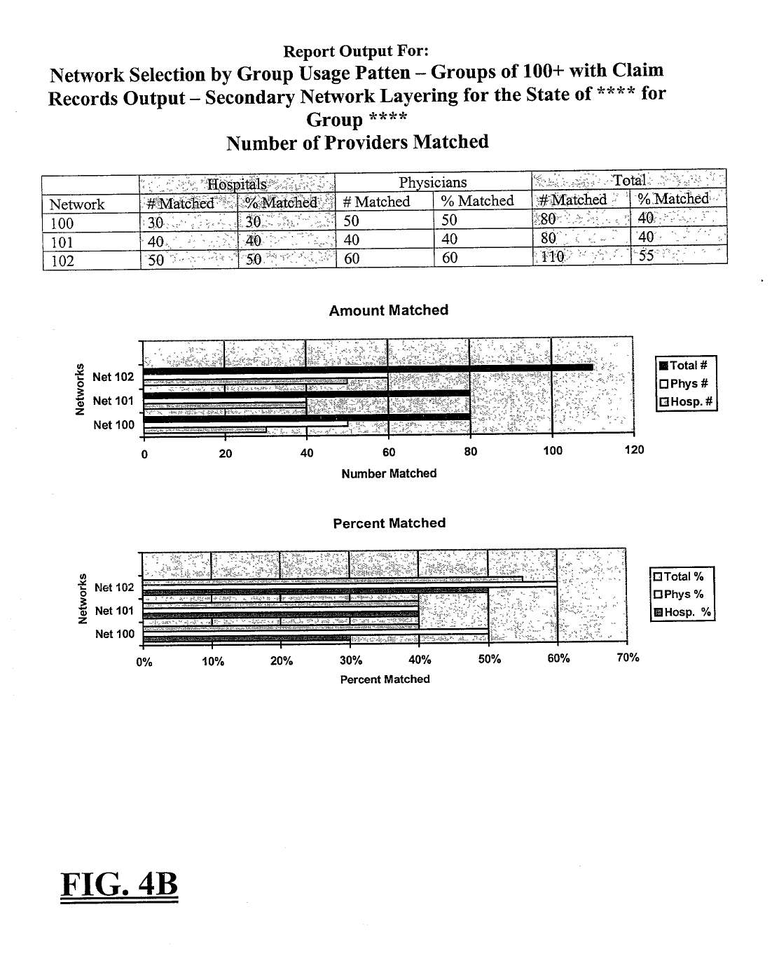

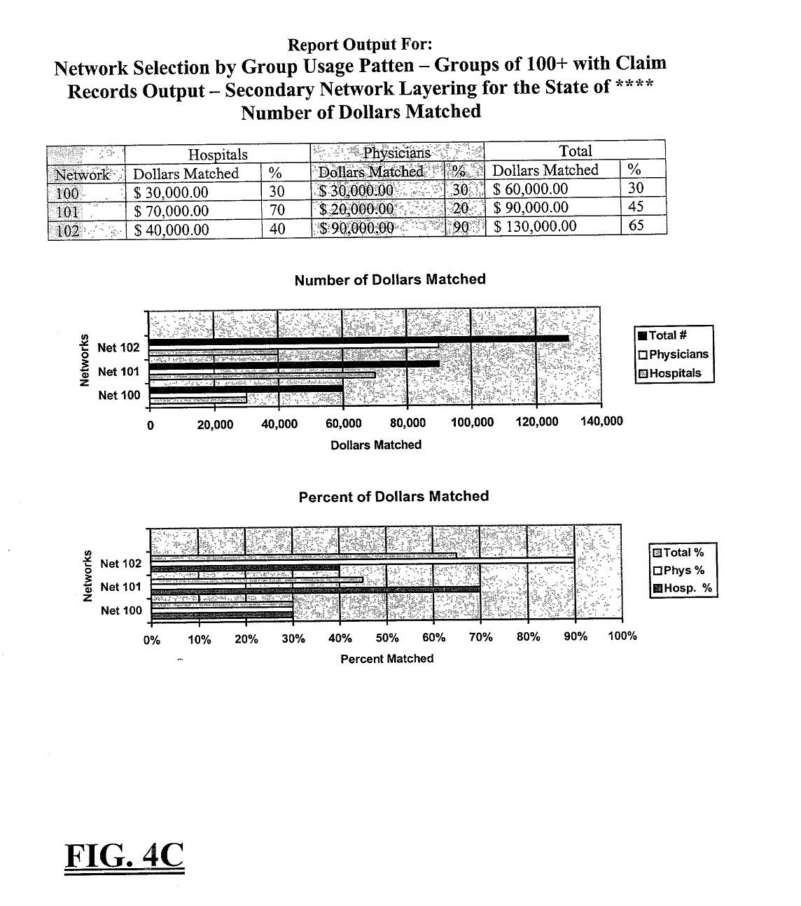

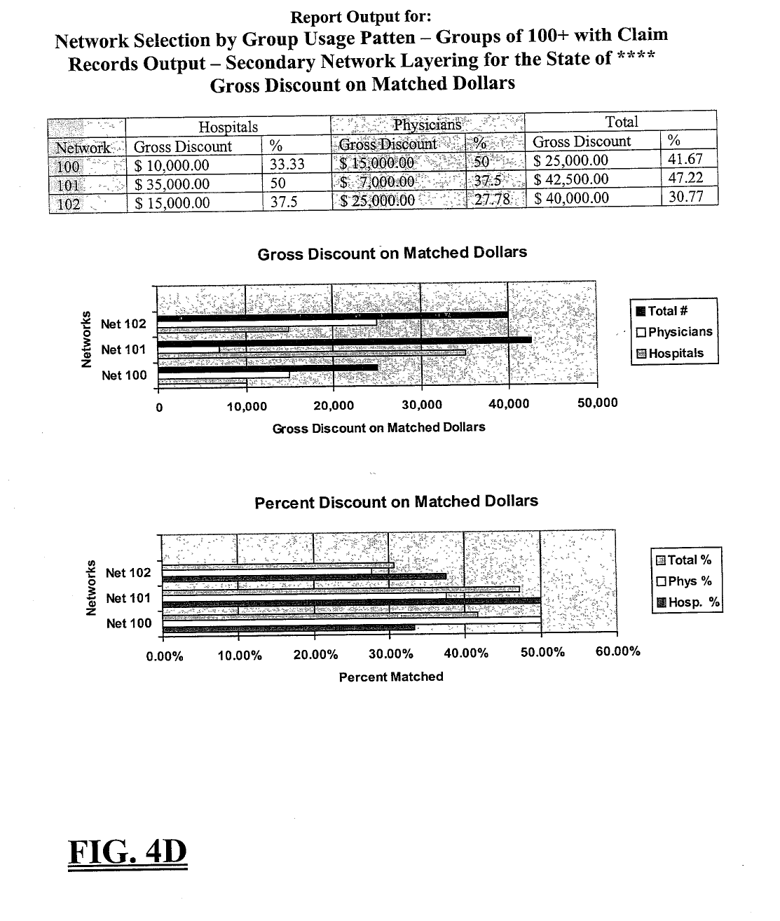

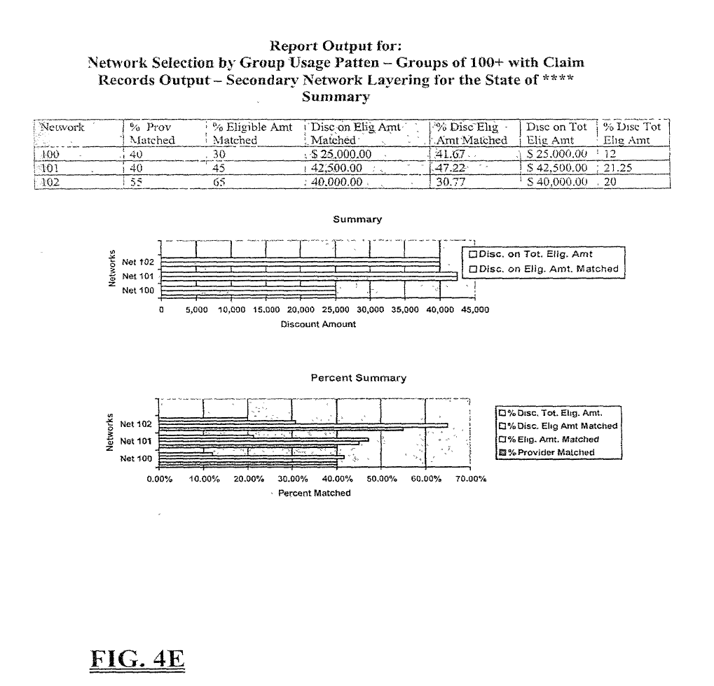

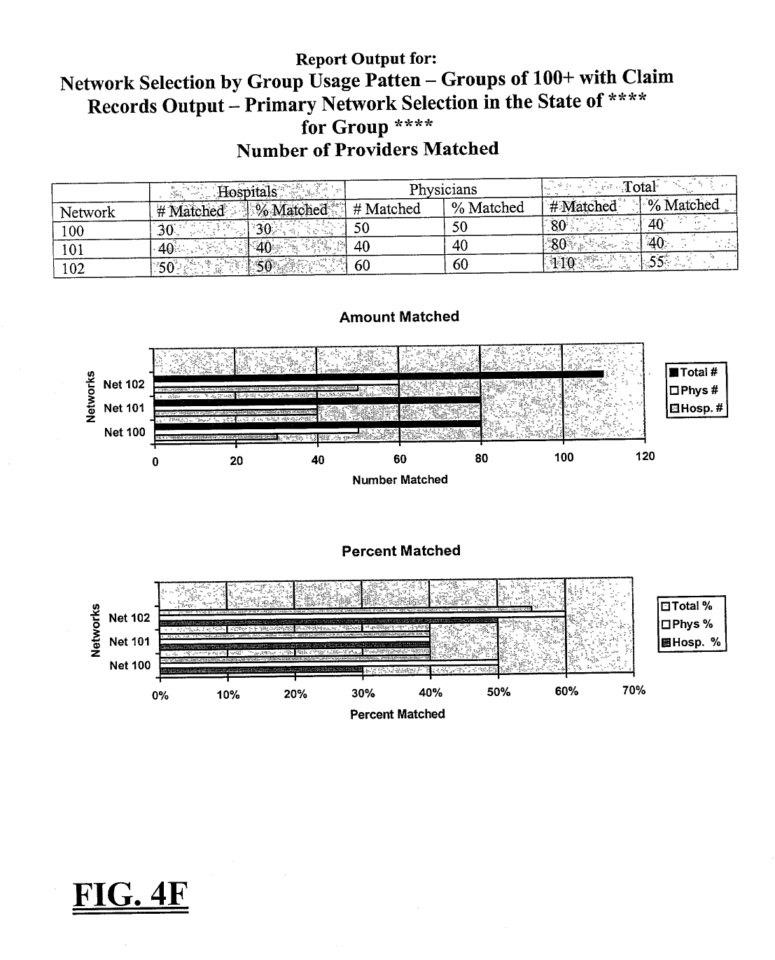

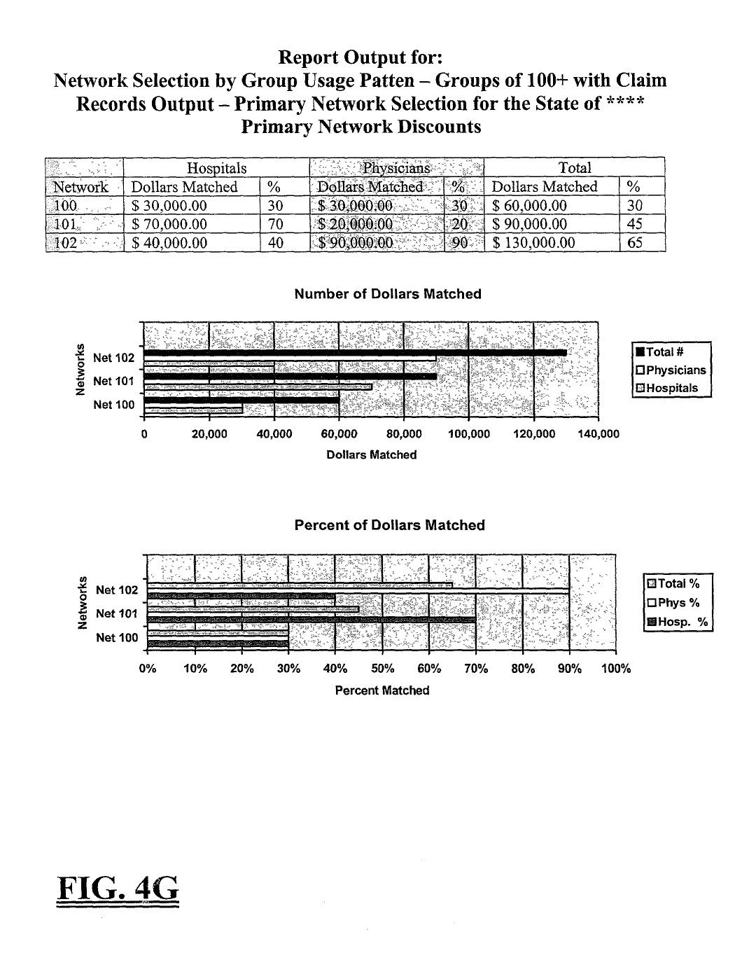

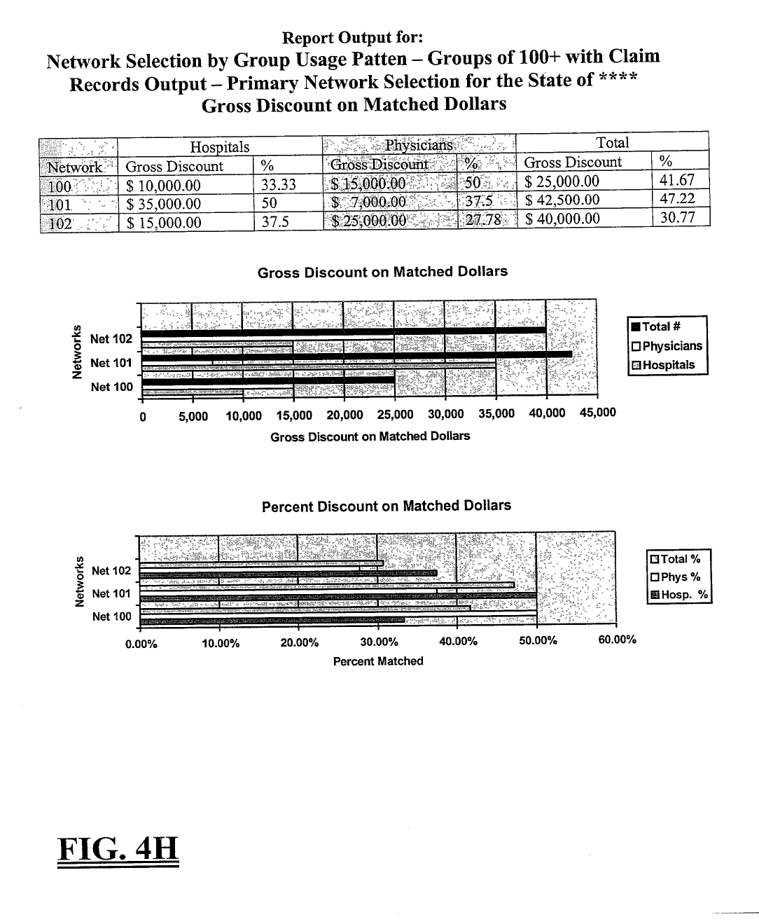

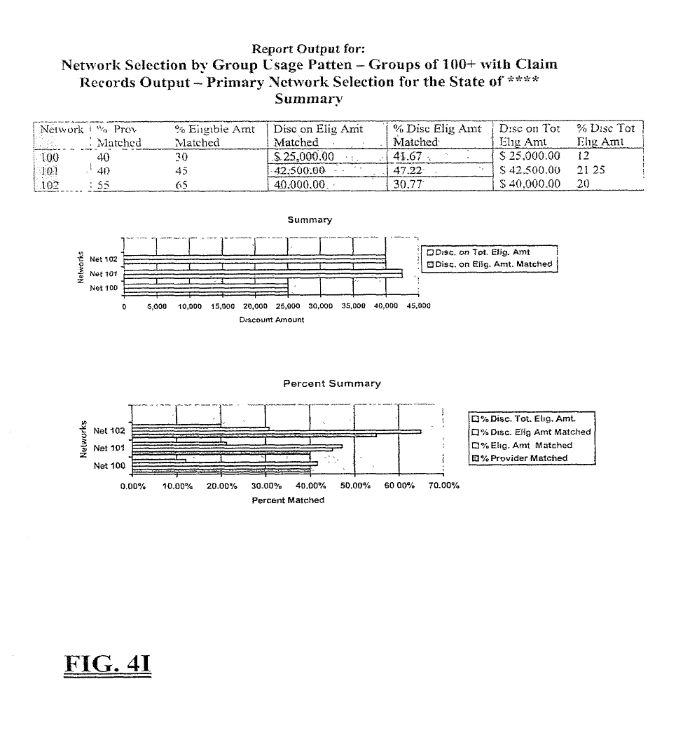

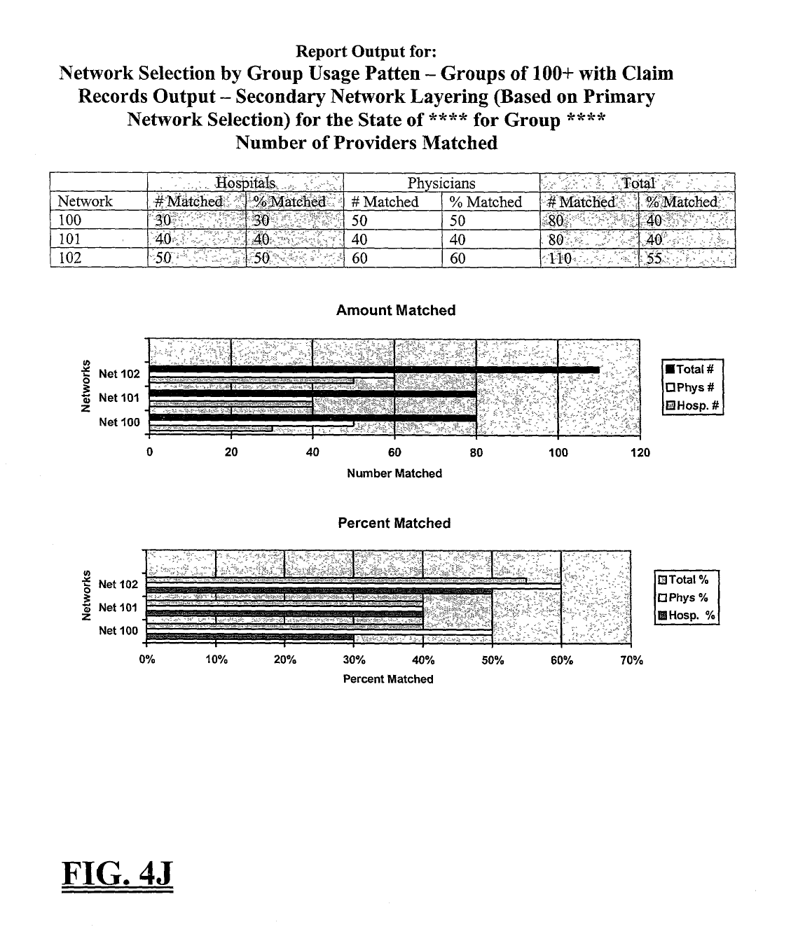

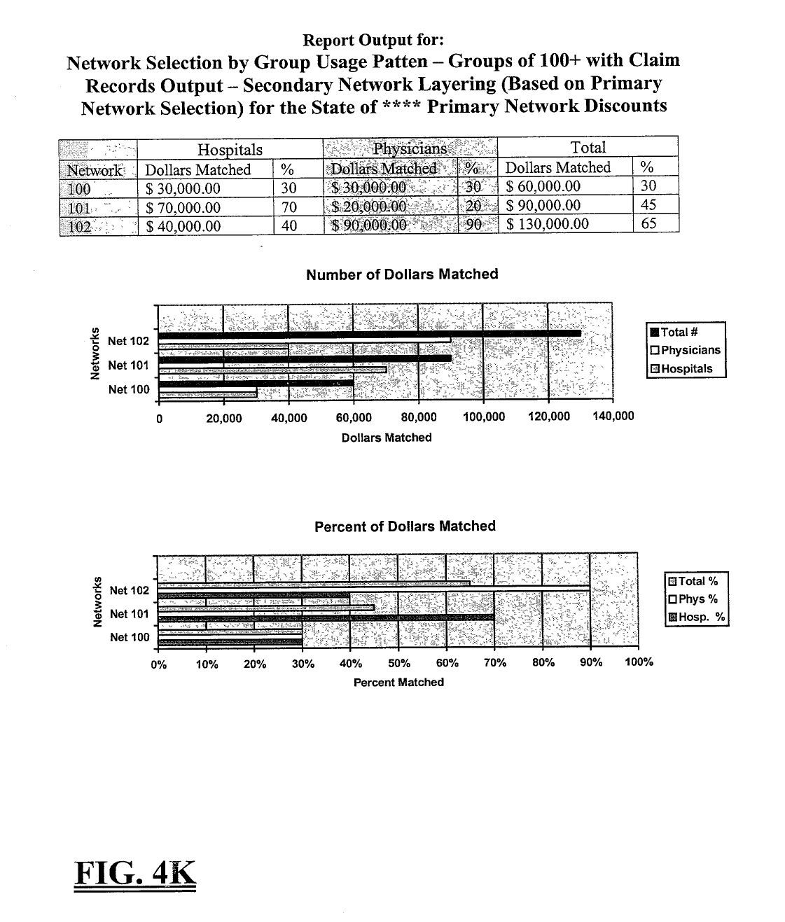

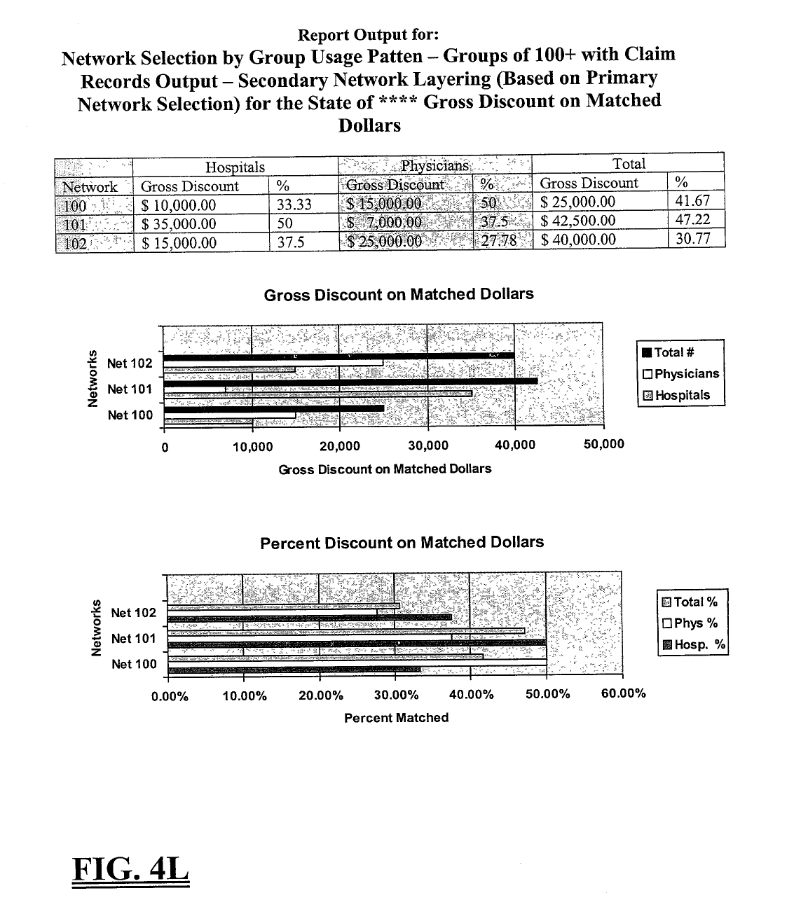

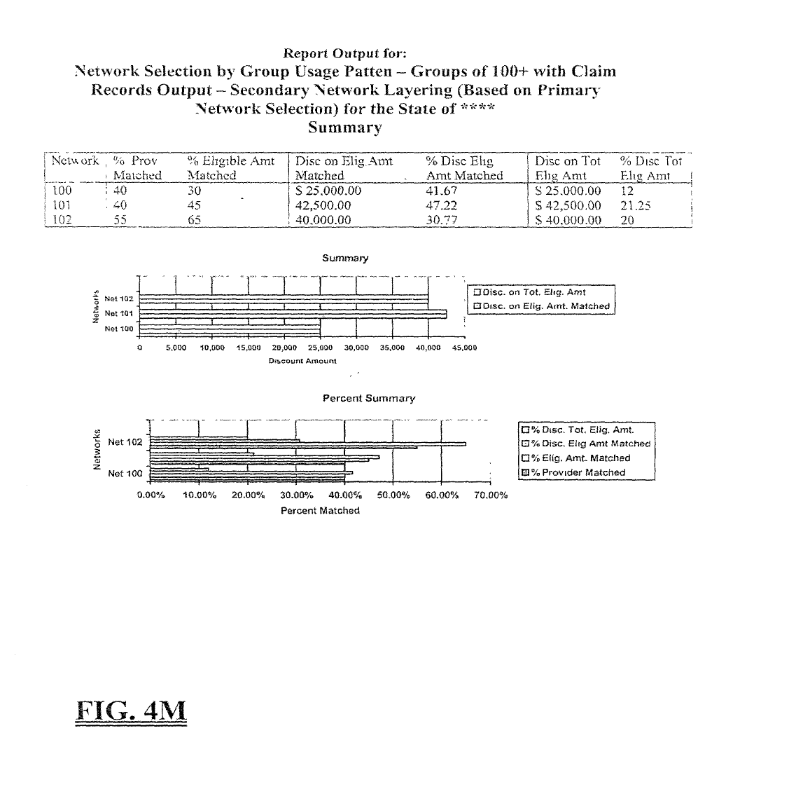

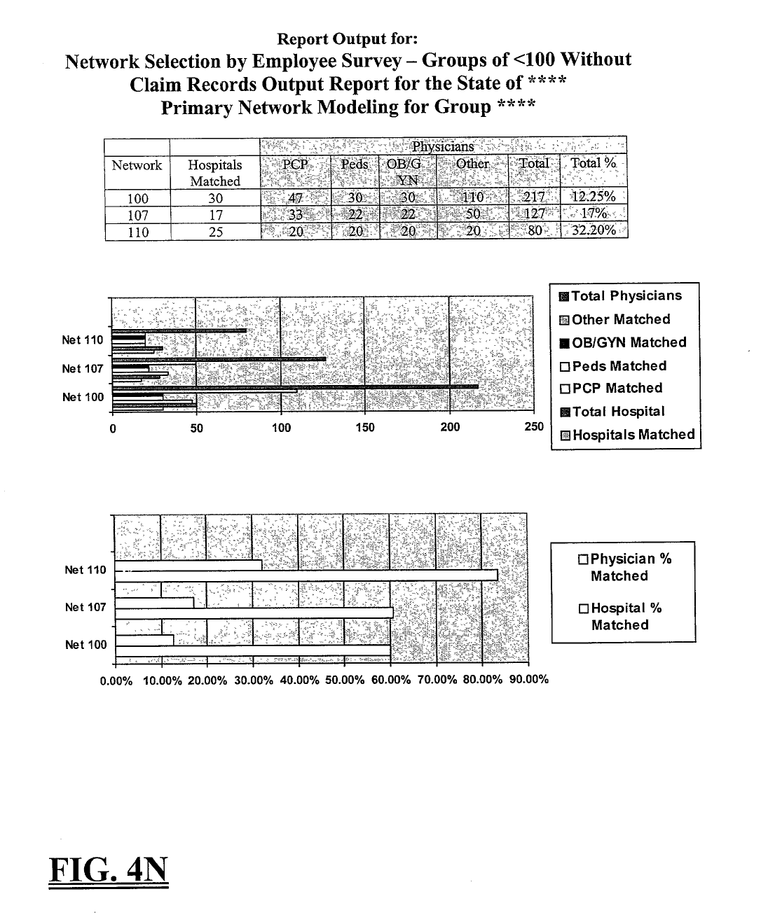

Referring now to FIG. 1B, the work flow for the Network Modeling module will be described for cases in which an employer group (of any size) has existing claim records in a digital format. Under government regulations, employers having groups of 100 employees or more must be provided claim payment information by the group's claim payer. This provides the basis for the employer to obtain detailed claim records and therefore the computer program of the present invention takes advantage of this preexisting data. In starting the Network Modeling computer program 10, the user first views a splash screen 26 displaying basic information about the data analysis system of the present invention. After a predetermined period of time the user is prompted to enter its user identification code at the entry screen 14. As discussed above, the computer program first determines whether the group has more than 100 employees and if the claim records are in the data processing system 28. If claim records exist the computer program displays a message stating that the network selection process report is running 30. The computer program then requests the format the user would like to view the report in tabular format, graphic format or both 32. Once the display format is chosen the computer program displays a progress indicator or bar 34 showing the progress of the report calculations. Once complete, the report output (Network Selection Output Report for the State of <name of particular state>) is displayed on the screen in the selected format 36. In the preferred embodiment, the computer program of the present invention is accessed via the Internet using another computer program called a browser. At this point the user can either use the Internet browser print function to obtain a printout of the results 38 or the user can request that the results be delivered to it by e-mail in a preselected format, such as a text file or a MS Word or Word Perfect file format 38. A sample of a report output for a Network Selection Output Report for the State of is shown in FIG. 4A. The sample in FIG. 4A shows network information in both tabular and graphical format. Three network have been identified and various characteristics of the doctors and hospitals in each network is displayed. For example, Network 100 includes 65 hospitals, 217 physicians having various specialties, and 10 medical labs. The report output makes comparing the networks simple. It is immediately apparent that Network 100 has more resources than Networks 107 or 110. The graphical representation shows the magnitude of the difference while the table provides actual numbers of the various resources in each network.

Another feature of the present method and apparatus is being able to perform detailed examination of the health care and benefits usage patterns of the employees and their family members. The computer program of the present invention will identify, either through the individual claim records or through the survey information, all of the doctors and hospitals that are preferred or are being used by the employees and their family members. The computer program will then match the usage pattern or preferred list of doctors and hospitals in the data table with the employer's current network. The computer program will also make the same comparison with all other networks in a central database in order to find the best match of the employee usage pattern or preferences and a particular network. Based on these various comparisons and calculations, the computer program will generate a series of reports identifying, based on the number of doctors and hospitals and/or by measurement of the claim dollars, which employee usage pattern is best matched with a particular network.

The network modeling computer program also analyzes the level of discounts or the effective rate of discounts that are available on various networks. The network modeling program can also compare discounts from various networks to certain standards such as Medicare or hospital averages so that the various networks can be ranked based on similarities to these standards.

Networks contract with doctors and hospitals on a discounted reimbursement schedule. These reimbursement schedules are based on several factors. For example, physicians are reimbursed for their services depending upon what services are performed. The services are identified by a series of codes defined by the American Medical Association. These codes are called CPT codes. There are over 10,000 CPT codes that define all types of services that a physician can provide to a patient. The standard way that a network contracts with a doctor is based upon a percentage of Medicare reimbursement schedules. Medicare, like others in the industry, attaches a dollar amount or value of payment to each of the CPT codes. The Medicare reimbursement level forms the baseline for measuring the effective rate of discount for which a network will contract. Extremely discounted networks are those networks that have deep discounts in place with its physicians, usually somewhere between 104% to 115% of the Medicare reimbursement schedules.

The computer program of the present invention will automatically retrieve complete reimbursement schedules from various networks for all 10,000+ CPT codes. The automatic retrieval can take place by various methods including but not limited to communicating with the network's computers over the Internet, via direct modem connections or other types of data acquisition including manual data entry. When the computer program examines each claim in the 100+ life employee group it examines whether the particular doctor or hospital is in a given network and measures the discounts for that particular CPT code given by the network. In this manner, the user can determine the total savings through discounts available in each network for particular physician services by examining each CPT code.

The discount basis used by hospitals in the contracting process with networks is much more complex. Networks use numerous methodologies in contracting with hospitals for discounts. One method of reimbursement for services rendered by a hospital is calculated on a per diem basis. Currently, the hospital services provided fall into thousands of specific codes similar to the manner that physician's services are defined by the CPT codes. This is on top of the 10,000+ physician codes. These services can be grouped together and reimbursed on a per diem or daily basis. For example, rather than look at the hospital's normal rate for a particular code, the network may contract with the hospital to pay X dollars per day or X dollars per code for particular services that are rendered. This is but one example of a multitude of methodologies used by networks.

Many of these methodologies can be quite complex. The computer program of the present invention takes a more simplistic approach. The computer program is loaded with a database containing percentages for each networks average in-patient and outpatient discount. The average total percentage of discounts is also included so when the codes for each claim are examined the average discount percentage for each examined network can be compared to the hospital claims. This allows the user to determine the average savings through discounts on the hospital services when physician and hospital discounts are combined, the user can then determine the best network for a particular employer or group of employees based upon the following two criteria; (1) the optimum matching of doctors and hospitals with the current and/or preferred utilization patterns of the employees and (2) the deepest measured discounts for a particular network. In this manner, the computer program allows users to determine the best primary network for a given group of employees.

The primary network is defined as the network having the best or the highest level of benefits provided to employees. Once the primary network is determined the user can perform a second examination of claims information or data to determine a secondary network to, so to speak, layer on top of the primary network, to capture discounts on the non-network claim set. The non-network claim set is defined as those claims that would not be paid at the highest benefit levels or more simplistically, the non-network benefits. The computer program begins by eliminating the known doctors and hospitals in which claims would be considered network claims. Once the network claims are excluded the result is a subset of the claims information or data defined as the non-network claims. The user can then perform a second matching on the non-network claims set with all networks that can be layered. As a practical matter, there are a limited number of networks that allow themselves to be layered on top of a primary benefit network. In this manner the user can capture additional discounts on the non-network claims set. By identifying the subset of non-network claims and matching them up with the best network, the user can determine a secondary cost savings to the employer and the employees.

Referring again to FIG. 1B, the Network Modeling module 10 continues by proceeding with network selection by group usage pattern for secondary network layering 40. The computer program prompts the user for the desired number of networks to display and the date ranges of claim records to be examined 42. The user is then prompted as to whether or not the report for the group usage pattern secondary network layering is to be displayed in tabular form, graphic form or both 44. Once the display format is chosen the computer program displays a progress indicator or bar 46 showing the progress of the report calculations. Once complete, the report output is displayed on the screen in the selected format 48. At this point the user can either use the Internet browser print function to obtain a printout of the results 50 or the user can request that the results be delivered to it by e-mail in a preselected format, such as a text file or a MS Word or Word Perfect file format 50. Several sample report outputs are shown in FIGS. 4B-4D. FIG. 4B is a report output for Network Selection by Group Usage Pattern—Groups of 100+ with Claim Records Output—Secondary Network Layering for the State of **** for Group ****—Number of Providers Matched. FIG. 4C is a report output for Network Selection by Group Usage Pattern—Groups of 100+ with Claim Records Output—Secondary Network Layering for the State of ****—Number of Dollars Matched. FIG. 4D is a report output for Network Selection by Group Usage Pattern—Groups of 100+ with Claim Records Output—Secondary Network Layering for the State of—Gross Discount on Matched Dollars. FIG. 4E is a report output for Network Selection by Group Usage Pattern—Groups of 100+ with Claim Records Output—Secondary Network Layering for the State of—Summary. Each of the sample report outputs shown in FIGS. 4B-4E include the information in tabular and graphical formats.

Network Modeling module 10 again continues by proceeding with network selection by group usage pattern for primary network selection 52. The computer program prompts the user for the desired number of networks to display and the date range of claim records to be examined 54. The user is then prompted as to whether or not the report for the group usage pattern primary network selection is to be displayed in tabular form, graphic form or both 56. Once the display format is chosen the computer program displays a progress indicator or bar 58 showing the progress of the report calculations. Once complete, the report output is displayed on the screen in the selected format 60. At this point the user can either use the Internet browser print function to obtain a printout of the results 62 or the user can request that the results be delivered to it by e-mail in a preselected format, such as a text file or a MS Word or Word Perfect file format 62. Several sample report outputs are shown in FIGS. 4F-4I. FIG. 4F is a report output for Network Selection by Group Usage Pattern—Groups of 100+ with Claim Records Output—Primary Network Selection in the State of **** for Group ****—Number of Providers Matched. FIG. 4G is a report output for Network Selection by Group Usage Pattern—Groups of 100+ with Claim Records Output—Primary Network Selection for the State of ****—Primary Network Discounts. FIG. 4H is a report output for Network Selection by Group Usage Pattern—Groups of 100+ with Claim Records Output—Primary Network Selection for the State of—Gross Discount on Matched Dollars. FIG. 41 is a report output for Network Selection by Group Usage Pattern—Groups of 100+ with Claim Records Output—Primary Network Selection for the State of—Summary. Each of the sample report outputs shown in FIGS. 4F-4I include the information in tabular and graphical formats.

Referring to FIG. 1C, Network Modeling module 10 further proceeds with network selection by group usage pattern with secondary layering based on primary network selection 64. The computer program prompts the user for the desired number of networks to display and the date range of claim records to be examined 66. The user is then prompted as to whether or not the report for the group usage pattern primary network selection is to be displayed in tabular form, graphic form or both 68. Once the display format is chosen the computer program displays a progress indicator or bar 70 showing the progress of the report calculations. Once complete, the report output is displayed on the screen in the selected format 72. At this point the user can either use the Internet browser print function to obtain a printout of the results 74 or the user can request that the results be delivered to it by e-mail in a preselected format, such as a text file or a MS Word or Word Perfect file format 74. At this point the computer program proceeds to the Network Disruption report 76, which is subsequently explained. Several sample report outputs are shown in FIGS. 4J-4M. FIG. 4J is a report output for Network Selection by Group Usage Pattern—Groups of 100+ with Claim Records Output—Secondary Network Layering (Based on Primary Network Selection) for the State of **** for Group—Number of Providers Matched. FIG. 4K is a report output for Network Selection by Group Usage Pattern—Groups of 100+ with Claim Records Output—Secondary Network Layering (Based on Primary Network Selection) for the State of—Primary Network Discounts. FIG. 4L is a report output for Network Selection by Group Usage Pattern—Groups of 100+ with Claim Records Output—Secondary Network Layering (Based on Primary Network Selection) for the State of—Gross Discount on Matched Dollars. FIG. 4M is a report output for Network Selection by Group Usage Pattern—Groups of 100+ with Claim Records Output—Secondary Network Layering (Based on Primary Network Selection) for the State of ****—Summary. Each of the sample report outputs shown in FIGS. 4J-4M include the information in tabular and graphical formats.

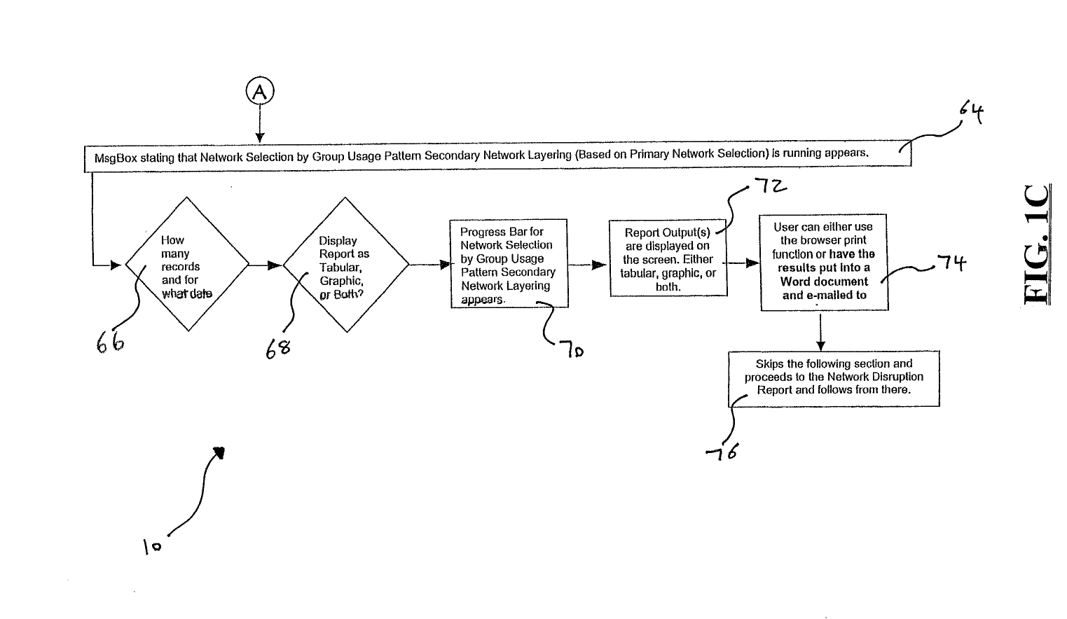

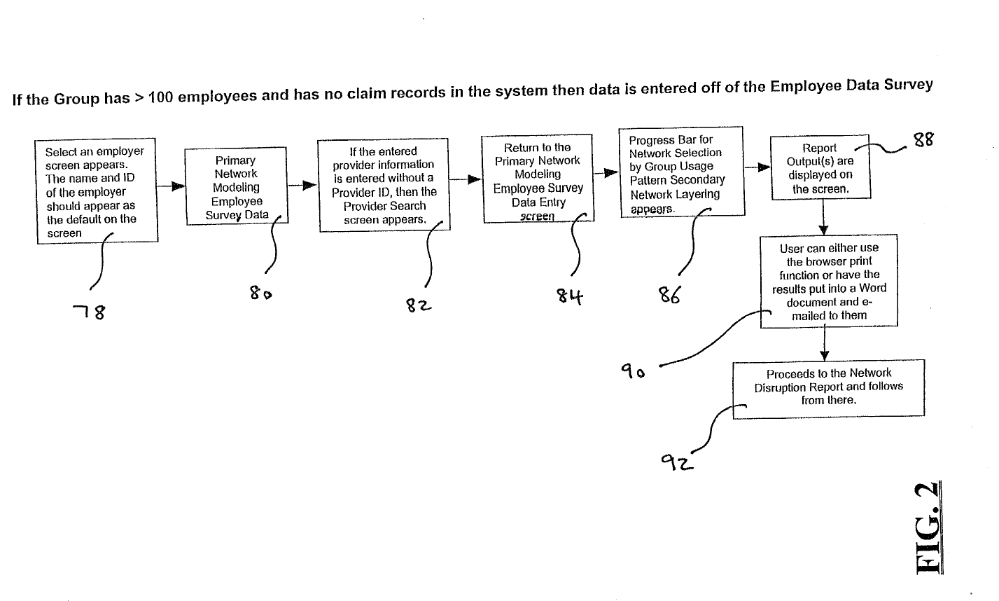

Referring now to FIG. 2, the work flow for the Network Modeling module 10 will be described for cases in which an employer group, regardless of size, that does not have claim records in a digital format. In this case provider information must be entered manually from an employee data survey. Of course, the employee data survey could be conducted electronically in order to create digital records thereby making data entry considerably more efficient. Both manual and automated methods of entering employee survey information are contemplated by the applicant.

When the user enters his or her user identification code 14, the Network Modeler module (FIG. 1B) tests if the group has more than 100 employees and has claim records in a preexisting digital format 28. If there are no claim records then the computer program prompts the user through a display monitor to select an employer 78. The name and identification of the employer, which corresponds to the user identification entered at 14, will appear as the default on the display screen in one preferred embodiment. After selecting an employer or the default 78, the employee survey data for the primary network modeling is entered into the computer program 80. If the entered provider information is loaded into the computer program without a provider identification code, a provider search screen appears 82. After and if the provider search screen appears 82, the computer program then returns to the employee survey data screen 84. The computer program next displays a progress indicator or bar 86 showing the progress of the report calculations. Once complete, the report output is displayed on the display screen 88. At this point the user can either use the Internet browser print function to obtain a printout of the results 90 or the user can request that the results be delivered to it by e-mail in a preselected format, such as a text file or a MS Word or Word Perfect file format 90. The computer program next proceeds to the Network Disruption report 92, explained subsequently.

The computer program for the Network Modeling module also provides analysis in cases where the employee group consists of less than 100 persons and/or the group does not have any readily available digital claim records. This scenario is very similar to groups of 100+ that do not have readily available digital claim records. Again, employee survey data for the primary network modeling is entered into the computer program. Several sample report outputs are shown in FIGS. 4N-4O. FIG. 4N is a report output for Network Selection by Employee Survey—Groups of <100 Without Claim Records Output Report for the State of ****—Primary Network Modeling Group ****. FIG. 4O is a report output for Network Selection by Employee Survey—Groups of <100 Without Claim Records Output Secondary Network Modeling (Based on Primary Network Selection) for Network **** in the State of Network Modeling provided by the computer program of the present invention also includes the ability to generate a disruption analysis report or Network Disruption report. A disruption analysis report is useful when an employer is considering changing networks for perceived cost savings through the capture of additional discounts. Most employers today are concerned about the potential of disruption to the employee population. For example, if an employer is using network ABC, there is an existing list of doctors and hospitals that the employees are using. Network XYZ might provide a better match for the employees and deeper discounts on the claims. The problem is that there may be a doctor or hospital used by an employee in network ABC who would not be in network XYZ. The employee who utilizes that doctor or hospital is going to be disrupted by a change of network vendors. It therefore becomes important to the employer to minimize disruption of its employee population and dissatisfaction within the workforce. This can be done by identifying employees who would be disrupted in the change and working through the process with the employee to minimize the disruption.

The computer program handles this situation for the employer by producing a list which includes but is not limited to the name of the employee, the names of the people in the employee's family, the name of the doctor or hospital in the current network used by that employee/family member who would not be in the new network. In addition, the computer program can also printout the names of all doctors in network XYZ who are in the same specialty and within the same zip code as the disrupted doctor. For example, Eric's wife Mary might see Dr. Smith who is a provider in the ABC network. Dr. Smith is identified by the computer program as not belonging to network XYZ. The disruption list would show Eric's name, Mary's name, Dr. Smith's name, a list of the doctors in XYZ who were in the same specialty as Dr. Smith, and located in the same zip code as Dr. Smith. This allows Eric and Mary to decide if any other doctors would be acceptable to them or whether a special recruitment effort was necessary for Dr. Smith so as to minimize the disruption. The special recruitment effort would involve getting Dr. Smith into network XYZ thereby preventing any disruption with Mary's normal relationship with Dr. Smith.

The Network Disruption report or analysis will now be described with reference to FIG. 3A. When the computer program for the Network Modeling module 10 reaches the network disruption analysis it displays a message stating that the network disruption analysis is running 94. The computer program then prompts the user for the desired number of networks to display and the date range of claim records to be examined 96. Next, the computer program initiates a dialog box that asks the user to enter a particular network number 98. A dialog box is simply a window that opens on a computer display screen in which text can be displayed and information entered. After the user enters the network numbers the computer program displays a progress indicator or bar 100 showing the progress of the disruption analysis calculations. Once complete, the disruption analysis is displayed on the screen 102. The user can then either use the Internet browser print function to obtain a printout of the results 104 or the user can request that the results be delivered to it by e-mail in a preselected format, such as a text file or a MS Word or Word Perfect file format 104.

Following the network disruption analysis the computer program displays a message stating that a general report of rankings based on network sales output is being created 106. The computer program then prompts the user for the desired number of networks to display and the date range of claim records to be examined 108. Next, the computer program displays a progress indicator or bar 110 showing the progress of the general report rankings 112. Once complete, the report output(s) for hospitals and physicians are displayed on the screen 112. The user can then either use the Internet browser print function to obtain a printout of the results 114 or the user can request that the results be delivered to it by e-mail in a preselected format, such as a text file or a MS Word or Word Perfect file format 114.

Referring to FIG. 3B, the process continues with the computer program displaying a message stating that a detailed report, as opposed to a general report, of rankings based on network sales output is being created 116. The computer program then prompts the user for the desired number of networks to display and the date range of claim records to be examined 118. In order to provide a detailed report of rankings based on network sales output, the computer program requires a range of CPT codes. These are the series of codes defined by the American Medical Association used to identify various medical services. The computer program prompts the user to select a range of CPT codes 120. If the CPT code range entered by the user is not available 122 then the default CPT code range is set 124. In this situation the user is then prompted to select a range from the default list 126. After either situation, entering a range of CPT codes or selecting form the default list, the computer program displays a progress indicator or bar 128 showing the progress of the detailed report rankings 128. Next, the report output is displayed on the screen 130. The user can then either use the Internet browser print function to obtain a printout of the results 132 or the user can request that the results be delivered to it by e-mail in a preselected format, such as a text file or a MS Word or Word Perfect file format 132. Finally, the computer program displays a message stating that all of the reports have been completed 134 and then the original splash screen is displayed 136 allowing a user to repeat the Network Modeling.

The network modeling plan also includes a method of analyzing employee benefits which comprises comparing discounts available from a network to “standards” and then displaying the results of the comparison. The standards may be selected from for instance, Medicare reimbursement schedules or information regarding average discounts from hospitals, among others. The network discounts are compared to the standards and then the employee benefit networks can be ranked according to their similarities to the standard discounts. Further, the standard discounts and the discounts available from an employee benefit network can be divided into groups. The groupings may be made based on types of claims which fall into certain CPT code ranges. With this division, the employee benefit networks can be ranked according to similarities to the standards but also showing a claim by claim comparison.

The computer program of the present invention also includes a Plan Design Modeling module used alone or in conjunction with the Network Modeling module and a Group Health claims module, described in more detail later. The Plan Design Modeling module forecasts changes in an employer's group health insurance benefit plan. In general, the computer program for Plan Design Modeling consists of a list of the current benefit configuration for a particular employer's group health insurance plan. In one embodiment the left side of a computer display screen contains a menu setting forth the current benefit configuration. For example, the menu describes the current deductibles in the plan and the current co-insurance reimbursement percentage above the deductible. After an employee pays a deductible for health services rendered, there is usually a cost sharing between the plan of benefits and the employee for the next level of expenses. This is called co-insurance. These co-insurance percentages can be different for network levels of benefits, non-network levels of benefits and a number of other items.

In this same embodiment the right side of the menu includes various parameters that make up the employer's current plan which can be altered. If desired the entire network could also be changed. Plan Design Modeling reviews individual claims and re-prices each claim based on the new plan or new networks discount schedule so the employer knows what a particular proposed plan of benefits would cost based upon past claims experience. For example, groups generally may expect a one-percent reduction in costs by changing the deductible from $100 to $200 based on actuarial formulas. A particular group's actual cost reduction will vary and therefore it becomes important to examine the details of the individual claims through a re-pricing mechanism.

The claims adjudication process for insurance companies and third party administrators typically examine many other details in addition to re-pricing of the claims. For example, when a claim comes into an insurance company, the claims adjudication process examines whether or not the individual employee was an eligible person within the group. Also examined is whether or not the claim codes are proper. Sometimes codes submitted by doctors and hospitals are what has been called “unbundled.” Unbundled codes are codes that have been divided into different components so the doctor and/or hospital can receive greater reimbursements. The adjudication process of insurance companies has the capability of then rebundling the unbundled codes and pricing the claims accordingly. The insurance company looks for duplicate claims submissions and hundreds of other details before it actually goes into a calculation process of what would be payable on a given claim that is submitted.

The computer program for Plan Design Modeling operates based on the assumption that the insurance company or the third party administrator, the party who actually paid the claim, has submitted all the details of the claim records correctly. The computer program then simply applies a different benefit model to those claims or the individual claim records in order to recalculate the cost or savings associated with a planned design change.

Despite the simplicity of the Plan Design Modeler in general, many details must be accounted for and handled in the process. For example, the computer program includes a general information screen that instructs users on how to recalculate individual claim lines. Other details arise from the fact that there are two basic plans that exist in the marketplace. One basic plan is called a base plus major medical plan and the second is called a comprehensive major medical plan. The base plus major medical plans are less prevalent today and are being phased out of the marketplace. These plans, for example, historically provide 100% coverage if an employee has a hospital-based benefit and a physician-based benefit is covered under the major medical after a deductible and co-insurance.

Most plans available today are called comprehensive major medical which are plans designed so the employee is responsible for a deductible and cost sharing on the next level of expenses between the plan and the employee, i.e., co-insurance. After the employee meets the co-insurance expense, the plan pays 100% of the benefits.

There are also a number of other scenarios that the Plan Design Modeler handles in calculating and/or forecasting the savings due to changes in health care plans. For example, a plan might pay a 90% benefit level after the deductible for an in-network doctor or hospital and pay a 70% co-insurance after a deductible if the employee happens to go to a non-network doctor or hospital. An interesting situation is when an employer has a network/non-network based benefit plan and an employee goes to a non-network doctor. The question becomes do the dollars that apply to the non-network deductible on that claim also apply to the network deductible. For example, if the benefit plan has a $100 deductible in-network and a $200 deductible out-of-network are the deductibles integrated, so that a non-network $100 would fill the expenses of the non-network claims for $100, and would also fulfill the deductible on the network deductibles so that the next dollar of network expenses would be payable under a cost-sharing basis. The integration of these different deductibles must be measured whether they flow upward, downward, or whether the flow or payments go both ways. The same applies to other items such as co-insurance expenses. The computer program of the present invention takes all of these scenarios into consideration.

Other aspects that may be modeled include but are not limited to: deductibles applying to institutional claims only, non-institutional claims, only or both, PCP, network ad non-network deductible or co-insurance buckets which may be integrated upwards, downwards or both ways, emergency coverage, prescription drug coverage, hospitalization expense coverage, external care facility coverage, surgical expense coverage, preventive care expense coverage, chiropractic care coverage, mental health coverage, and chemical dependency coverage.

Another area that is of particular interest today is the ability to model prescription drug claims. Prescription drug claims in today's managed care environment are escalating at a much faster rate of inflation than other components of the medical cost, and insurance companies are using various techniques to combat this inflation of prescription drug costs. The computer program of the present invention can also model a virtually unlimited variety of prescription drug plans designed within a benefit program.

Another feature of the present invention is the ability to substitute different networks into the Plan Design Modeler module. As a result, the computer program will not only be taking into consideration the different benefit configurations but also the discounts of a new or proposed network. For example, an existing plan might use network ABC, and a particular claim is not in a network or only has a 10 percent discount. If a network is substituted in the calculation process, the user might get a 20 percent discount on a particular claim, leading to higher savings in conjunction with the change of benefits.

The Plan Design Modeler module also can generate specialty output reports. These reports are designed specifically for insurance companies or third party administrators. When an insurance company goes through the process of renewing an employee group or setting renewal rates, the underwriter uses a renewal formula. The computer program of the present invention automatically calculates the renewal formula and integrates the result with the Plan Design Modeler module so plan design adjustments can be taken into consideration, in addition to network savings or proposed savings, in the specialty output reports for an insurance company underwriter. This series of reports or calculations fully automates the renewal process for the insurance company or the third party administrator. Without the present invention an insurance company underwriter receives the claims information or data and performs a series of manual calculations to determine the renewal rates charged to a particular employee group. This information is given to a marketing representative of the insurance company who delivers the renewal action to the employer of the group. This usually generates numerous questions by the employer about hypothetical adjustments. The Plan Design Modeler adjusts to the employee's hypothetical changes in real time for the customer, showing the actual rates that would be generated under alternative plan designs.

The current method used today for determining the impact of changes on a health benefits plan consists of a marketing representative receiving a request for alternate plan designs, going back to the underwriters, the underwriters applying an actuarial formula (not an exact claim recalculation) and then generating new renewal rates based upon the alternative plan design. The marketing representative then contacts the group to schedule a second meeting to present the alternative plan rates. Of course, when presented with new options the customer will request further changes requiring the entire process to be repeated. The computer program of the present invention allows the marketing representative to access the Plan Design Modeler and perform recalculations for customer in real time, rather than take one, two or even three weeks to deliver alternative plan design rates to the customer.

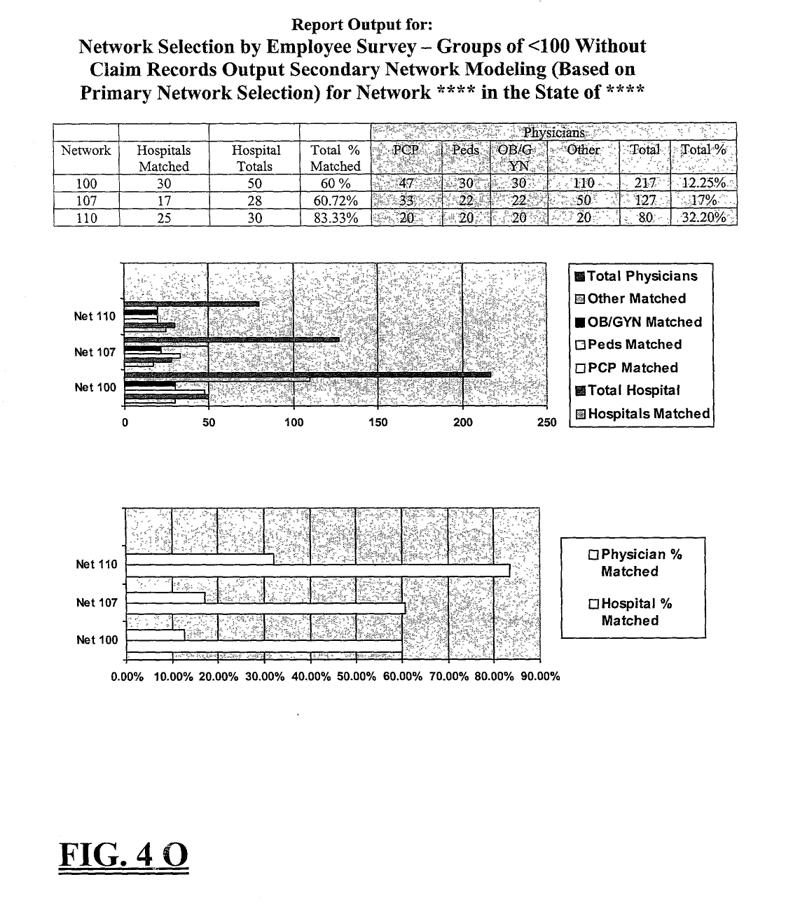

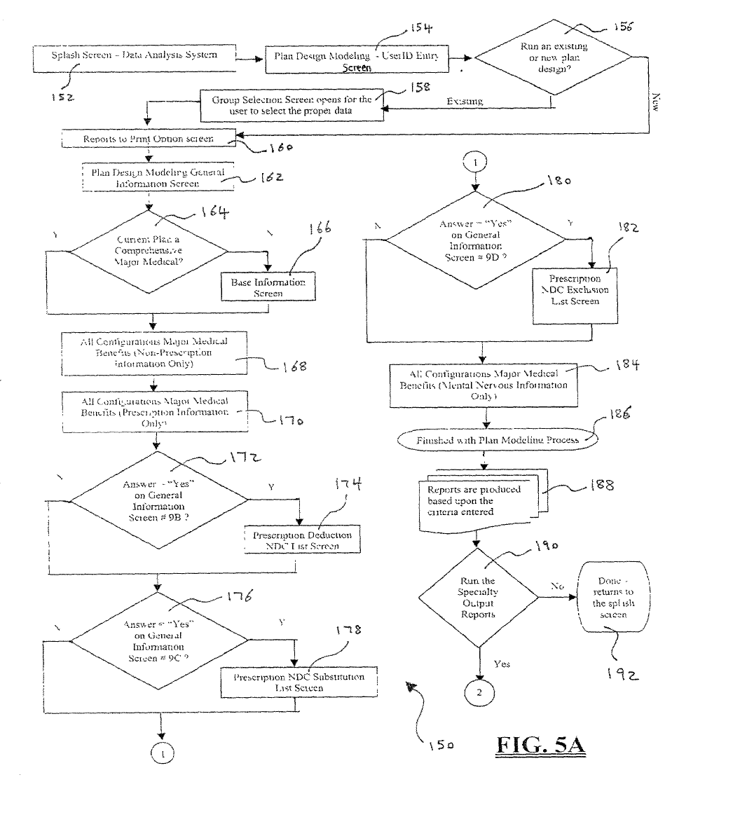

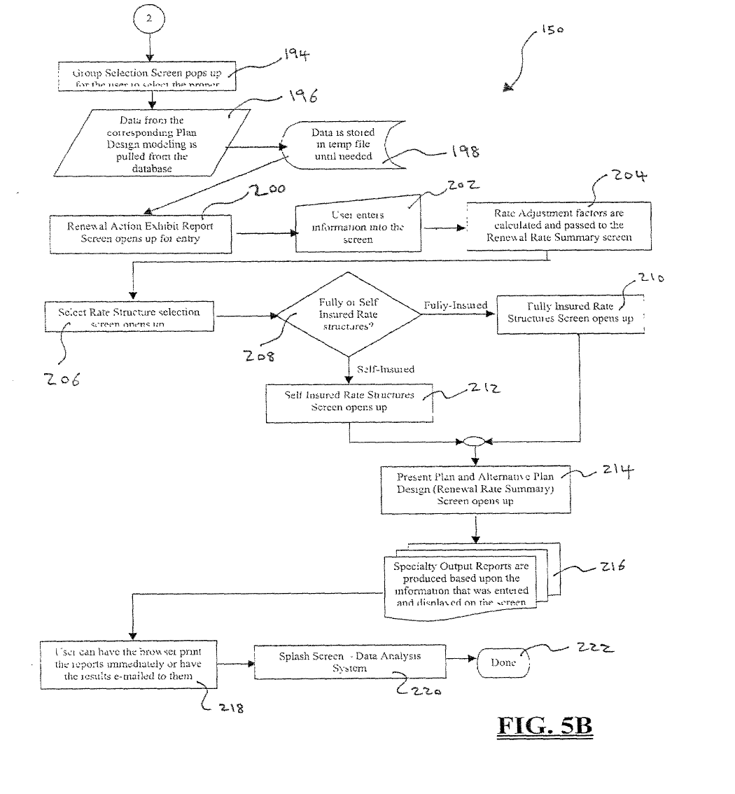

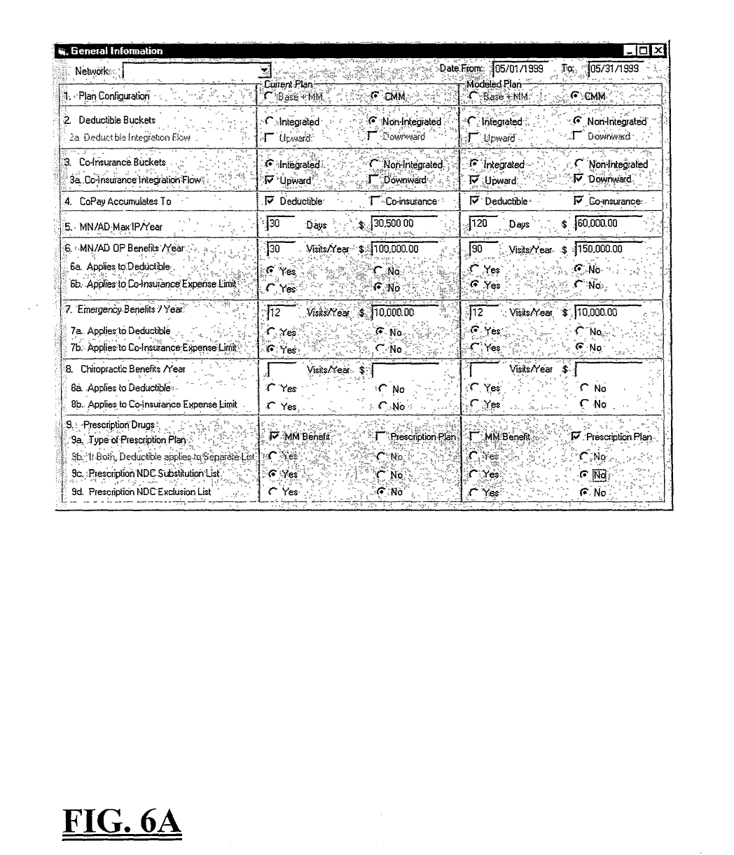

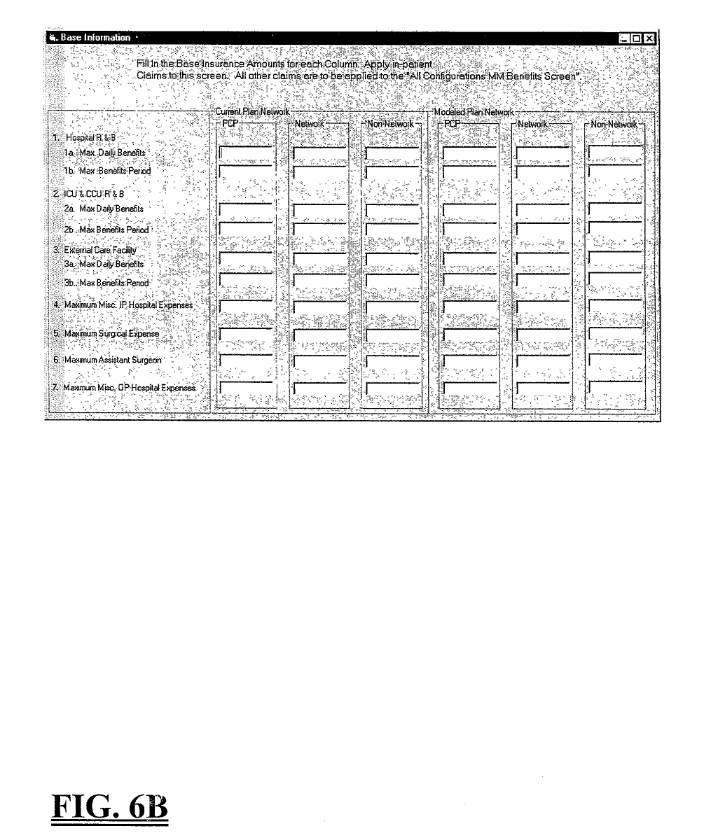

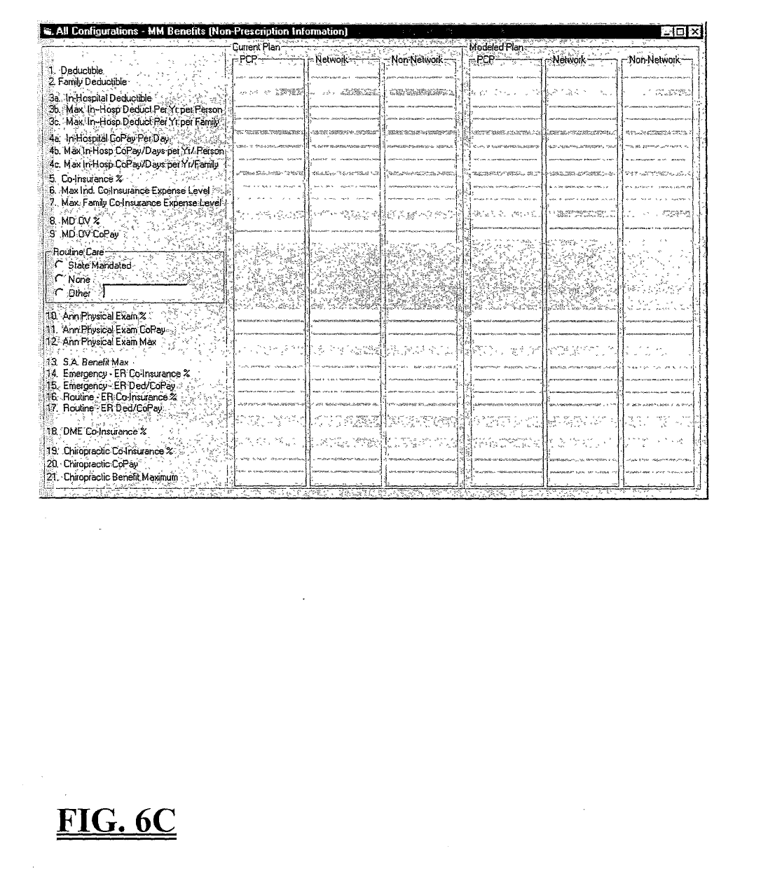

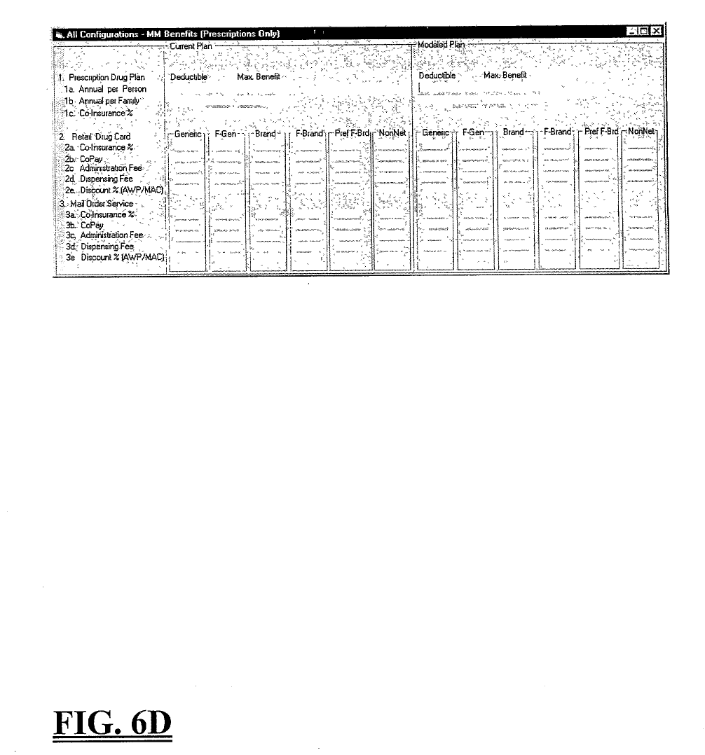

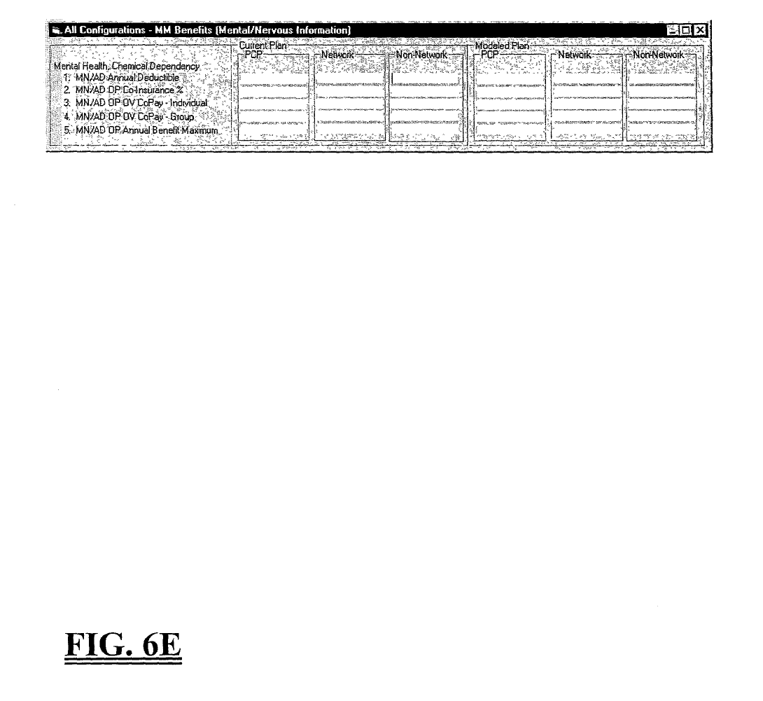

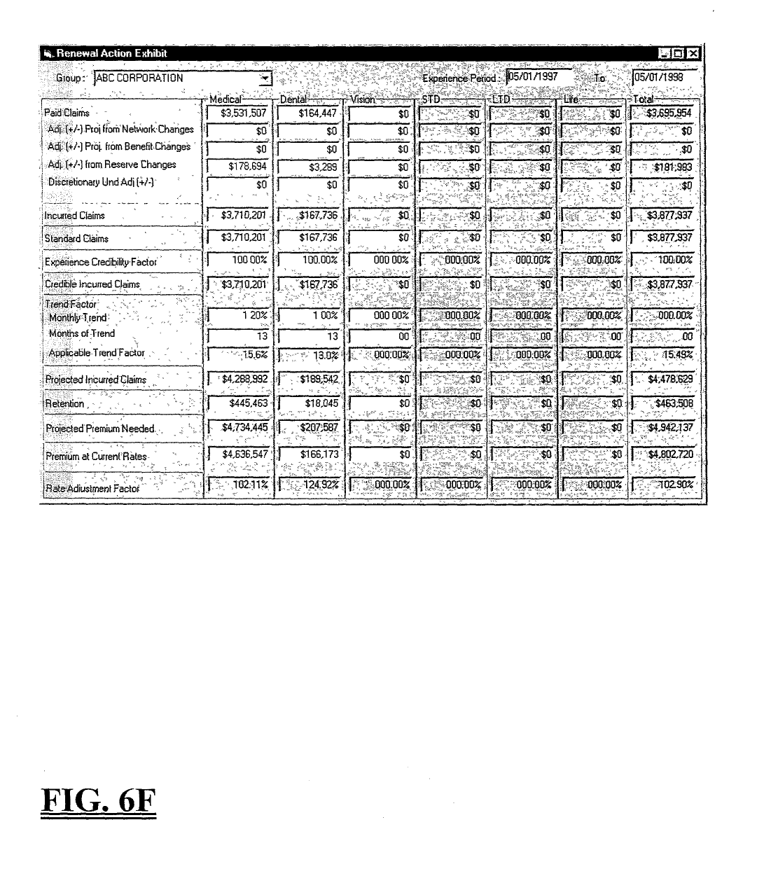

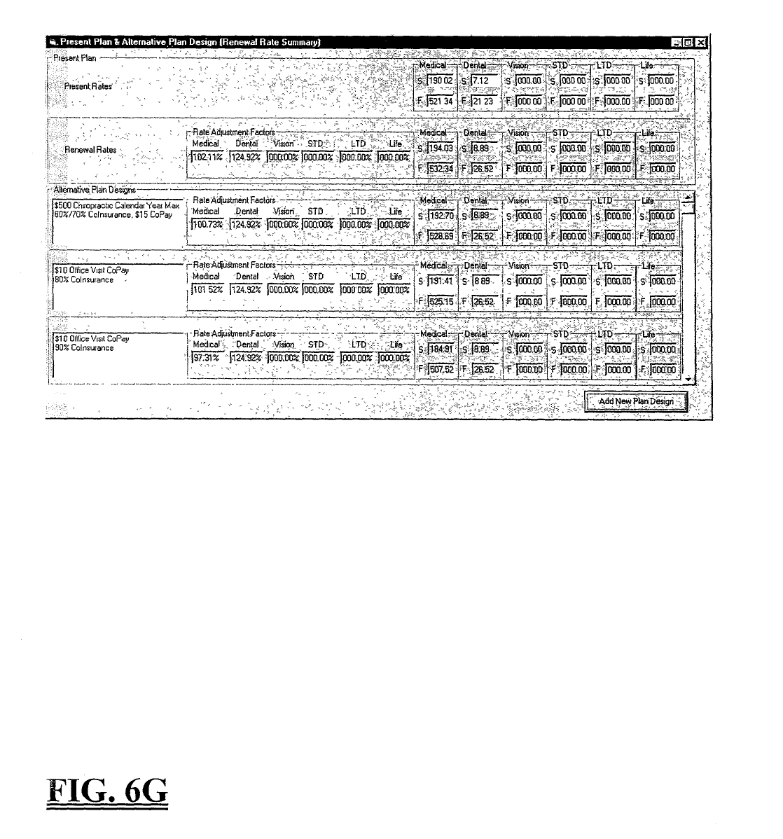

Now referring specifically to FIG. 5A, the Plan Design Modeling module 150 will be described in further detail. In starting the Plan Design Modeling computer program 150, the user first views a splash screen 152 displaying basic information about the data analysis system of the present invention. After a predetermined period of time the user is prompted to enter its user identification code at the entry screen 154. The user is then prompted as to whether to run an existing or new plan design 156. If the user elects to run an existing plan design a group selection screen opens 158 allowing the user to select the proper data. In either case, the computer program then asks the user which reports are desired 160 which is followed by the Plan Design Modeling general information screen 162. FIG. 6A shows one contemplated embodiment of the Plan Design Modeling general information screen. The purpose of this screen is to reprocess claim data under various scenarios and determine potential cost savings to the group. Users will input the date of the information they are entering followed by the other information on the screen. Choices are made independently for each plan column. This screen contains a combination of radio buttons, check boxes, and list boxes to be selected and/or entered into by the user. The screen is broken down by columns. Column 1 represents the “Current Plan” and column 2 represents the “Modeled Plan”. The Current Plan is the plan that the customer has at the time of entry. The Modeled Plan is what the user would like to achieve. Column 2 entries are based upon the numbers that the customer would like to see.

The user will begin by entering the date range for the information that is entered, which can cross calendar years and/or plan years. Plan years refers to a twelve (12) month financial period, usually corresponding to a set of charged rates. This has no bearing on a calendar year, which is important in how benefits are calculated. The data stored in the database tables is stored by calendar years. Therefore there may need to be a joining of tables to retrieve all necessary information. (1) Plan Configuration—data entry is through radio buttons which are active for each column. CMM is the default. The user will select “Base+MM (Base plus Major Medical)” or “CMM (Comprehensive Major Medical)” from column 1. The user will make a separate selection for column 2. (2) Deductible Buckets—data entry is through radio buttons active for each column. The user will select “Integrated” or “Non-integrated” from column 1. The user will make a separate selection for column 2. Deductible Buckets hold the amount of money from a patient's payments that are to be applied toward the total deductible amount that the patient is responsible for covering. Once the deductible bucket is full, the patient's deductible pre-requisite is met and the insurance company is then responsible for up to the contracted percentage for that patient's medical care. (2a) Deductible Integration Flow—data entry is through check boxes in the row enabled if the user selects the Integrated radio button in row 2. The user will select Upward, Downward or both in column 1. The user will then make a separate selection for Column 2. The integration flow tells how the deductible affects each level, if at all. There are three basic levels of medical care within a line of business: PCP (primary care physician), Network, and Non-network listed in descending order. An example of upward integration flow would be if a patient goes to a Network doctor, the amount that the patient pays toward the deductible requirement would flow up into the PCP bucket as well. The Non-network deductible bucket for that patient would not be affected. Downward integration flow would be the opposite of upward integration flow. The amount that the patient pays toward the deductible requirement for the Network doctor visit would flow down into the Non-Network bucket. If both flows are selected, no matter what type of doctor the patient goes to see, all of the buckets are filled with the deductible amount paid by the patient. This logic will be used when calculating the modeled plans for the plan types.

(3) Co-Insurance Buckets—data entry is through radio buttons active for each column. The user will select Integrated or Non-Integrated from column 1. The user will make a separate selection for column 2. Buckets hold the amount of money from a patient's payments that go toward the total patient's co-insurance out of pocket expense limit. Once the bucket is full, the patient's co-insurance out of pocket expense limit is reached and the insurance company covers up the contracted percentage for that patient's medical care. (3a) Co-Insurance Integration Flow—data entry is through check boxes in this row enabled if the user selects the Integrated radio button in row 3. The user will select Upward, Downward or both in column 1. The user will make a separate selection for column 2. As previously explained, there are three basic levels of medical care within a line of business, PCP (primary care physician), Network, and Non-network listed in descending order. Upward and downward integration flow also applies as described previously. (4) CoPay Accumulates To—data entry is through check boxes displayed for each column. Either one or both choices may be selected on this row (Deductible only, Co-Insurance only or both). The user will make a separate selection for column 2. This row indicates whether the co-pay from the patient goes toward filling the Deductible bucket and/or the Co-Insurance bucket for the patient and/or family. (5) MN/AD Max IP/Year—this row holds the maximum number of days and the dollars per year that can be spent on Mental/Nervous and Alcohol/Drug in-patient treatment for the given plan. (6) MN/AD OP Benefits/Year—this row holds the maximum number of visits and the dollars per year that can be spent on Mental/Nervous and Alcohol/Drug outpatient treatment for the given plan. (6a) Applies to Deductible—data entry is through radio buttons. The user will enter data for both columns. This row tells whether or not the amount paid by the patient for the outpatient care applies to the patient's deductible bucket. If it does apply, the application must check the integration flow, if any, of the plan's deductible and apply accordingly. (6b) Applies to Co-insurance Expense Limit—data entry is through radio buttons. The user will enter data for both columns. This row tells whether or not the amount paid by the patient for the outpatient care applies to the patient's co-insurance out-of-pocket expense limit. If it does apply, the application must check the integration flow, if any, of the plan's co-insurance and apply accordingly. If the expense does not apply to the deductible, the plan will pay a benefit even if the claimant's deductible requirements haven't been satisfied. (7) Emergency Benefits/Year—this row holds the maximum number of visits and the dollars per year that can be spent on emergency care for the given plan. (7a) Applies to Deductible—data entry is through radio buttons. This row tells whether or not the amount paid by the patient for the emergency care applies to the patient's deductible bucket. If it does apply, the application must check the integration flow, if any, of the plan's deductible and apply accordingly. (7b) Applies to Co-insurance Expense Limit—data entry is through radio buttons. This row tells whether or not the amount paid by the patient for the emergency care applies to the patient's co-insurance out-of-pocket expense limit. If it does apply, the application must check the integration flow, if any, of the plan's co-insurance and apply accordingly. Again, if the expense does not apply to the deductible, the plan will pay a benefit even if the claimant's deductible requirements haven't been satisfied. (8) Chiropractic Benefits/Year—this row holds the maximum number of visits and the dollars per year that can be spent on chiropractic treatment for the given plan. (8a) Applies to Deductible—data entry is through radio buttons. This row tells whether or not the amount paid by the patient for the chiropractic care applies to the patient's deductible bucket. If it does apply, the application must check the integration flow, if any, of the plan's deductible and apply accordingly. (8b) Applies to Co-insurance Expense Limit—data entry is through radio buttons. This row tells whether or not the amount paid by the patient for the chiropractic care applies to the patient's co-insurance out-of-pocket expense limit. If it does apply, the application must check the integration flow, if any, of the plan's co-insurance and apply accordingly. As described previously, if the expense does not apply to the deductible, the plan will pay a benefit even if the claimant's deductible requirements haven't been satisfied.

Finally, heading (9) covers Prescription Drugs. (9a) Type of Prescription Plan—data entry is through check boxes for major medical benefit and Prescription Plan. Either one or both choices may be selected on this row. The user will select for each column. If both are selected, the user has the next option enabled. Otherwise, the user goes on to the “Prescription NDC Substitution List” option. (9b) Deductible Applies to a Separate List—this option is only enabled if both types of plans are selected in row 9a. If yes is selected, this will trigger the Prescription Deductible NDC List screen to show up later in the application. If no is selected, nothing is affected later on. (9c) Prescription NDC Substitution List—data entry is through radio buttons. If yes is selected, this will trigger the Prescription NDC Substitution List screen to show up later in the application. If no is selected, nothing is affected later on. (9d) Prescription NDC Exclusion List—data entry is through radio buttons. If yes is selected, this will trigger the Prescription NDC Exclusion List screen to show up later in the application. If no is selected, nothing is affected later on.

Referring again to FIG. 5A, after the user selects and/or enters the appropriate information into the Plan design Modeling general information screen 162, the computer program asks the user whether the current health care benefits plan is a comprehensive major medical plan 164. Comprehensive major medical plans are designed so the employee is responsible for a deductible and cost sharing on the next level of expenses between the plan and the employee, i.e., co-insurance. After the employee meets the co-insurance expense, the plan pays 100% of the benefits.

If the user answers no, the current plan is not a comprehensive major medical plan, then the computer program displays a base information screen 166. FIG. 6B shows one contemplated embodiment of the base information screen. The purpose of this screen is to reprocess claim data under various scenarios and determine potential cost savings to the group. This screen will be used to enter base plus major medical benefit information. All other benefits are to be entered on the “All Configurations/MM Benefits (Non Prescription)” screen. Users will fill in the Base Insurance dollar amounts for each column in the Current Plan Network and Modeled Plan network sections. Entries are made independently for each plan column. The columns for entry are PCP, Network, and Non-Network. The following items apply to the Base Information screen. (1) Hospital R&B=hospital room and board. (1a) Max. Daily Benefit=maximum daily benefit amount for hospital room and board. (1 b) Max Benefit Period=maximum benefit period for hospital room and board. (2) ICU & CCU R&B=intensive care and coronary care room and board. (2a) Max. Daily Benefit=maximum daily benefit amount for intensive care and coronary care room and board. (2b) Max Benefit Period=maximum benefit period for intensive care and coronary care room and board. (3) Ext. Care Facility=extended care facility. (3a) Max. Daily Benefit=maximum daily benefit amount for extended care facility. (3b) Max Benefit Period=maximum benefit period for extended care facility. (4) Maximum Misc. IP Hospital Expenses=maximum miscellaneous in-patient hospital expenses. (5) Maximum Surgical Expense maximum amount for any surgical expenses. (6) Maximum Assistant Surgeon=maximum amount for assisting surgeons. (7) Maximum Misc. OP Hospital Expenses=maximum miscellaneous outpatient hospital expenses.

If the current plan is a comprehensive major medical plan or once the user enters the requested base information, the computer program displays a screen showing all configurations of major medical benefits, excluding prescription drug information 168 (“All Configurations—MM Benefits (Non-Prescription Information”). FIG. 6C shows one contemplated embodiment of the All Configurations—MM Benefits (Non-Prescription Information) screen. The purpose of this screen is to reprocess claim data under various scenarios and determine potential cost savings to the group. The major medical benefit amounts for each column will have already been entered by the user in the current plan and modeled plan sections. The columns for data entry are PCP (Primary Care Physician), Network, and Non-Network. The following items apply to the general information screen shown in FIG. 6C. (1) Deductible—the amount of the individual benefit deductible to be paid by the individual person or employee. (2) Family Deductible—the amount of the family benefit deductible to be paid by the insured. (3a) In-Hospital Deductible—the amount of the deductible if the patient (employee) is in the hospital. (3b) Max In-Hosp Deduct per Yr per Person—the maximum deductible amount per year for in-hospital stay(s) per individual. (3c) Max In-Hosp Deduct per Yr per family—the maximum deductible per year for in-hospital stay(s) per family. (4a) In-Hospital CoPay per Day—the in-hospital stay(s) daily co-pay amount. (4b) Max In-Hosp CoPay/Day per Yr/Person—the maximum co-pay days per year per individual for in-hospital stay(s). (4c) Max In-Hosp CoPay/Day per Yr/Family—the maximum co-pay days per year per family. (5) Co-Insurance %—the percentage of the expense that the insurance plan is responsible to cover. (6) Max Ind. Co-Insurance Expense Level—the maximum expense dollars that the co-insurance percentage is applied to before the insurance plan pays 100 percent of the cost for an individual. (7) Max Family Co-Insurance Expense Level—the maximum family expense dollars that the co-insurance percentage is applied before the insurance plan pays 100 percent for all family members. (8) MD OV %—medical doctor office visit percentage. (9) MC OV CoPay—office visit co-pay.

The screen in FIG. 6C continues as follows. Routine Care: State Mandated—if routine care is mandated by the particular State then options 10-12 are disabled (these options will be explained below). Routine Care: None—if the patient (employee) does not have any routine health care coverage then options 10-12 are disabled. Routine Care: Other—the user can enter some other plan type into a text box, which has no affect on the disability of any of options. (10) Ann Physical Exam %—the percentage of the amount due for annual physical exams that the insurance plan is responsible to cover. (11) Ann Physical Exam CoPay—the amount of the co-pay for the annual physical that the individual pays. (12) Ann Physical Exam Max—the maximum benefit payable for an annual physical exam. (13) S.A. Benefit Max—supplemental accident benefit maximum. (14) Emergency ER Co-Insurance %—the percentage of emergency cost co-insurance. (15) Emergency ER Ded/CoPay—the amount of the emergency room deductible or co-pay. (16) Routine ER Co-Insurance %—the percentage of the routine emergency cost co-insurance the plan is responsible for covering. (17) Routine ER Ded/CoPay—the routine emergency room deductible or co-pay that the patient is responsible for covering. (18) DME Co-Insurance %—durable medical equipment co-insurance percentage that the plan is responsible for covering. (19) Chiropractic Co-Insurance %—the percentage of the chiropractic cost co-insurance that the plan is responsible for covering. (20) Chiropractic CoPay—the amount of the chiropractic co-pay the patient is responsible for covering. Finally, (21) Chiropractic Benefit Maximum—the maximum amount of benefits payable by the plan per year.

Once the user has entered any required information into the All Configurations—MM Benefits (Non-Prescription Information) screen, the computer program displays a screen showing prescription drug information for all configurations of major medical benefits 170 (All Configurations—MM Benefits (Prescription Only)). FIG. 6D shows one contemplated embodiment of the All Configurations—MM Benefits (Prescription Only) screen. The purpose of this screen is to reprocess prescription claim data under various scenarios and determine potential cost savings to the group. Users will fill in the major medical amounts for each column in the Current Plan and Modeled Plan sections. Each item is listed below in the Display section. The column the user will input the information is based upon the type of Retail Drug Card and Mail Order Service they are entering. Deductible and Maximum Benefit dollar amount columns only apply to rows 1 a and 1 b. Row 1 c is a standalone row. None of the column headings apply to the row. Generic, F-Generic (F-Gen), Brand, F-Brand, Preferred F-Brand (Pref-FBrd), and Non-Network (NonNet) columns apply to rows 2 through 3e. The following items apply to the Base Information screen. Under heading (1) are factors related to Prescription Drug Plans. (1a) Annual Per Person—the annual prescription amount per individual with the prescription drug plan. (1 b) Annual Per Family—the annual prescription amount per family with the prescription drug plan. (1 c) Co-Insurance %—the percentage of the cost the plan is responsible for of the cost of prescriptions with the prescription drug plan. Under heading (2) are factors related to Retail Drug Cards. (2a) Co-insurance %—the percentage of the cost the plan is responsible for of the cost of prescriptions with a retail drug card. (2b) CoPay—the amount of the co-pay the individual is responsible for with regard to prescriptions with a retail drug card. (2c) Administration Fee—the retail drug card administration fee. (2d) Dispensing Fee—the retail drug card dispensing fee. (2e) Discount % (AWP/MAC)—the percent of the discount. Under heading (3) are factors related to Mail Order Service. (3a) Co-Insurance %—the percentage of the cost the plan is responsible for of the cost of prescriptions through a mail order service. (3b) CoPay—the amount of the co-pay the individual is responsible for prescriptions purchased through a mail order service. (3c) Administration Fee—the mail order service administration fee. (3d) Dispensing Fee—the mail order service dispensing fee. (3e) Discount % (AWP/MAC)—the percent of the discount.

The Plan Design Modeling module 150 next begins to process various pieces of information entered by the user. Referring again to FIG. 5A, the computer program determines whether the user answered “YES” on the General Information screen (FIG. 6A) to line number 9b (whether a deductible applies to a separate list of prescription drugs) 172. If the answer was “YES” then the user is prompted with a prescription deduction NDC list screen 174 (not shown). NDC is an acronym for the National Drug Code. All or most prescription drugs are identified with an NDC code. The user then selects the NDC number(s) that when purchased, their purchase amount is added to the employee's deductible bucket. Next, the computer program determines whether the user answered “YES” on the General Information screen (FIG. 6A) to line number 9c (whether prescription NDC numbers or prescriptions can and should be substituted in predetermined situations) 176. If the answer was “YES” then the user is prompted with a prescription NDC substitution list screen 178 (not shown). The user is able to select the NDC number(s) that are to substitute the present numbers for usage. If a substitution is made, the computer program will calculate how the substitution will affect the cost of the claims.

Continuing, the computer program determines whether the user answered “YES” on the General Information screen (FIG. 6A) to line number 9d (whether any prescription NDC numbers should be excluded) 180. If the answer was “YES” then the user is prompted with a prescription NDC exclusion list screen 182 (not shown). The user is able to select the NDC number(s) that are not to be included in the claim cost calculations. Finally, the computer program displays a screen showing mental and/or nervous information for all configurations of major medical benefits 184 (All Configurations—MM Benefits (Mental/Nervous Information)). FIG. 6E shows one contemplated embodiment of the All Configurations—MM Benefits (Mental/Nervous Information) screen.

The purpose of this screen is to reprocess claim data under various scenarios and determine potential cost savings to the group. Typically, the information for the major medical amounts in each column will have already been entered by the user in the current plan and modeled plan sections. The columns for data entry are PCP (Primary Care Physician), Network, and Non-Network. The following items apply to Mental/Nervous and Alcohol/Drug outpatient treatments. MN/AD Annual Deductible—the annual deductible for the patient (employee). MD/AD OP Co-Insurance %—the co-insurance percentage the plan is responsible to cover. MN/AD OP OV CoPay—Individual—the office visit co-pay amount the patient (employee) pays for individual therapy sessions. MD/AD OP OV CoPay—Group—the office visit co-pay amount the patient (employee) pays for group therapy sessions. Finally, MD/AD OP Annual Benefit Maximum—the maximum annual benefit for a patient (employee).

At this point the Plan Design Modeling module 150 is finished with the plan modeling process 186. The computer program next produces reports based upon the previously entered criteria 188. The user is then prompted whether or not to run specialty output reports 190. If the user does not want specialty output reports run 190 then the computer program is done 192 and returns to the initial splash screen 152. If the user requests specialty output reports then the computer program continues as shown in FIG. 5B. First, a group selection screen opens for the user to select the proper group 194. The computer program then retrieves information or data from the corresponding Plan Design modeling previously completed and stored in a database 196. This data is then stored in a temporary file until needed 198. Next, a renewal action exhibit report screen is displayed 200 and the user then enters the appropriate information into the screen 202.

The renewal rate action exhibit report is one of two specialty reports. The second specialty report is the present plan and alternate plan design renewal rate summary. These two reports are used in conjunction with the Plan Design Modeler by insurance companies and/or third party administrators to calculate renewal rates for employer groups. The renewal rates are normally calculated by insurance companies and/or third party administrators by an underwriting department. The renewal rate calculation process is fundamentally a projection by the underwriter of the rates that need to be charged to a particular group in the following year to generate sufficient income to cover incurred claims plus expenses. The starting point for such an analysis is examination of the current level of paid claims. To the paid claims, the underwriter adds or deletes certain dollar amounts to determine his or her best estimate of the current level of incurred claims. The items that are added and deleted include such things as changes in reserves, changes in the projected paid claims level due to a benefit change, changes due to network discount changes, changes in the paid claims due to the removal of shock loss or large claims that are not likely to repeat, and underwriting discretionary amounts. When all of these amounts are added together, the underwriter determines the best estimate of the current level of incurred claims. This level is then projected forward twelve months as an estimate of what the incurred claims will be in the next period. This forward projection is a multiple of medical trend and other such items times the current level of incurred claims.

Once the underwriter has determined the estimate for future incurred claims level, he or she will then add the expenses necessary to run the business to determine the total income necessary in the renewal period. A comparison is then done of the current income level produced by the current rates against the needed income level or the future projection of the needed income level to determine a renewal factor. The renewal factor will either be an increase in rates or a decrease in rates depending upon whether more or less income is needed in the renewal period. This renewal factor is applied to the existing rates to determine the renewal charged rates. FIG. 6F shows one contemplated embodiment of the Renewal Action Exhibit information screen.

Once the renewal factor is generated, the program goes to the present and alternate plan design renewal rate summary. In this exhibit, the existing rates are shown for each line of business. A multiplication is then performed by applying the renewal factor developed in the previous exhibit times the current rates. One of the things that this automated process incorporates is the exact dollars developed in the plan design modeler for a change of benefits. If you recall earlier, this is one of the factors that an underwriter takes into consideration when he projects the future incurred claims cost. Once the exact prediction in the plan design modeler is made of the impact of a benefit change on the existing group's claim cost, the underwriter can add that in to his renewal calculation to determine alternative plan design renewal rate factors. These alternative factors are stored by the system and applied in the renewal rate summary to give real time renewal rates as the insurance company marketing representative sits with the employer and examines different scenarios.

As previously mentioned, the renewal process is very time-consuming under the present state of the art. Once the initial renewal presentation is made to the employer, the marketing representative for the insurance company needs to go back to the underwriter in today's environment to produce renewal rates in a complicated calculation process. And this entire process takes two to three weeks. By the underwriter signing off on a few elements in the renewal rate exhibit as his determination of the best projection of the items to be added to determine the incurred claims, the renewal process can then be turned over to the marketing representative and, in a real time environment, the combination of the plan design modeler and the specialty reports can produce an unlimited variety of benefit alternatives and actual rates for the employer as the marketing representative sits with the employer in a consultative process. FIG. 6G shows one contemplated embodiment of the Renewal Action Exhibit information screen.

The computer program continues by calculating benefit rate adjustment factors and transfers these factors to the renewal rate summary screen 204 (not shown). The user is then prompted with a rate structure selection screen 206 to determine whether a fully insured rate structure or a self insured rate structure applies 208. If the user selects the fully insured rate structure a separate screen opens 210 for entry of that particular rate structure. If the user selects the self insured rate structure a different screen opens 212 for entry of that rate structure.

Once the rate structure information is entered, whether fully or self insured, a present/alternative plan design screen (renewal rate summary) opens 214 for the users review. The computer program then produces the specialty output reports based upon the information entered and displayed on the screen 216. The user can then either use the Internet browser print function to obtain a printout of the results 218 or the user can request that the results be delivered to it by e-mail in a preselected format, such as a text file or a MS Word or Word Perfect file format 218. The computer program then returns 220 to the initial splash screen 152 and the plan design modeling process is complete 222.

The process and computer program for renewal rate calculations automates the renewal activities of insurance companies and third party administrators. The process involves data acquisition of the output of the network modeling and plan design modeling programs, which is then incorporated into and processed within the renewal formulas used by insurance companies. By using the output of the network modeling and plan design modeling programs the renewal rate calculation process is made more efficient through automation.

Currently, insurance companies and third party administrators calculate renewal rates for an employer by initially producing a record of the paid claims for the employer during the previous policy year. The insurance company then collects the paid claim numbers, which are then forwarded to the underwriters. The underwriters then make adjustments to the paid claims numbers to eventually produce what is called an incurred claim number. Incurred Claims is defined as the total number of claims during a given examination period.

The adjustments performed by the underwriters to produce the incurred claims number can include such things as discretionary underwriters discounts. Discretionary underwriters discounts include practices such as removing a large claim from the paid claim data that is not likely to recur in the following policy period. An example would be a person who in the prior policy year was a cancer victim, had a lot of claims and eventually died in the past policy year. Such claims will naturally not recur in the future policy years. Underwriters will frequently remove this type of paid claim from the claim data in order to more reliably predict the future liability of the insured group.

In addition, underwriters generally produce claim reserves for incurred claims that have not actually reached the insurance company for payment, which are called IB&R Reserves. Some companies include open claim reserves. If there is a known open claim that is incurring paid claims, insurance companies may attempt to predict the future liability on that claim and include that as a claim reserve.

The final adjustments that occur to pay claims come from the actuarial department of insurance companies. For example, if there is a proposed benefit plan change, the actuaries will calculate the statistical factor that will result either upwards or downwards from the change in the benefit plan.

All of these numbers are added up to produce what is called an incurred claim figure, which is the future prediction of what the claims will be during the next policy year. Underwriters then calculate a credibility factor to apply against the incurred claim figure. Depending upon the size of an employer's group of employees, more credibility is given to the actual claims data and less credibility to the actuarial prediction of the incurred claim data. As an employer's group claims get larger their claims experience becomes more credible. For example, a group of 250 lives might be 70% credible according to the underwriters formulas. In that case, the underwriter multiplies the actual incurred claims by 0.7, multiplies the statistical actuarial produced incurred claims by 0.3 and adds the two numbers together to produce the starting point for the future liability in the next policy year.

Incurred Claims are then traded forward based upon the formulas the insurance companies use for medical inflation trend, increased utilization and any number of other factors which combine to produce a trend factor. Through these steps the projected liability for the employer group is determined for the next policy year. To this number the insurance company adds its retention or its expenses (the cost of doing business) to produce the final needed premium from the group in the next policy year. This number is compared to the premium number that is generated from the current rates to produce an adjustment factor, either upwards or downwards. The adjustment factor is then applied to the old rates to produce new rates. The underwriter then produces a renewal package and forwards it to the marketing department. The marketing department of the insurance company then meets with the employer to review the renewal calculations and go over what the future rates will be if the employer group decides to renew its benefit plan.

Many times the renewal rates presented to the employer are unacceptable. The employer typically requests adjustments in the various benefits or other parts of the program, whether the benefits themselves or the network, to lower the impact of the renewal rate adjustment. The marketing department of the insurance company must then take these requests and return to the underwriter. The underwriter then gets together with the actuarial department to produce statistical data or adjustments. For example, if the employer wants to look at a higher deductible in order to lessen the impact of the rate increase, the actuarial department will produce a statistical adjustment factor to lower the cost of the projected claims due to the increase in the deductible. Once this number is generated from the actuarial department, it is again provided to the underwriting department who recalculates all the formulas and sends the information back to the marketing department. The marketing department then contacts the employer to establish a second meeting to review the adjustments that were previously discussed. This entire process can take anywhere from as short as five days to several weeks and the process may be repeated several times. If the results of the second meeting are not acceptable to the employer, further adjustments or suggestions are made and thus the cycle repeats in its entirety.

The renewal rate calculations process of the present invention automatically implements the various formulas used by the insurance companies by allowing the underwriter to input the initial paid claim data, the reserves, and other statistical information for use in determining the renewal rate calculations. Once the initial renewal package is generated, the entire process is turned over to the marketing department. A marketing representative then establishes a meeting with the employer and reviews the renewal action with the employer. If the employer, as is typical, wants to see potential alternatives, such as benefits adjustments or network adjustments, these calculations can be run in real time in front of the employer by the marketing representative. The adjustments from the network modeling and plan design modeling programs are automatically received and inserted into the appropriate positions within the renewal rate calculations.

The renewal rate calculations program is then executed and final rates for the proposed adjustments are generated and reviewed with the employer. If the employer wants to see further adjustments or refinements, the process is then repeated. The time frame for each presentation of calculations and adjustments to the employer could take as little as 3-5 minutes by use of the network modeling, plan design modeling and renewal rate calculations program modules working in conjunction.

Consensus will be reached by the employer as to what is an acceptable renewal action and plan design and/or network design. The computer program will then generate an acceptance form to be executed, either manually or electronically, by the employer. The form will describe the final accepted plan and the rates and the employer will execute this form. Usually the marketing representative will execute the form electronically and transmit it to the various operating units within the insurance company or the third party administration company (or TPA company) so that the final design and acceptance of the renewal action can occur in one meeting and implementation can begin immediately within the insurance company.

This aspect of the present invention will completely automate the renewal process and eliminate time and man power required to presently carry out the renewal process. The insurance companies repeated calculation process by the underwriting department and the actuarial department on every adjustment requested by the employer can be decreased. This will lead to lower man power needs in both underwriting and actuarial departments of insurance companies.

It will also increase the persistency of an employer group with the insurance company due to the decreased time involved in the process. The employer will be able to control the renewal process providing it more incentive to develop better benefit plans. Typically, what happens once a large rate increase is delivered is that the marketing person goes back to the insurance company with suggestions. Meanwhile, the employer feels that it must protect itself from receiving this large rate increase and starts talking with other potential vendors, insurance companies and TPAs, who may provide the benefits at a lower cost. This process is eliminated by an active modeling session using the present invention. Consensus can be reached in one setting and executed, which prevents the employer from seeking other options and providing opportunities for competitors.

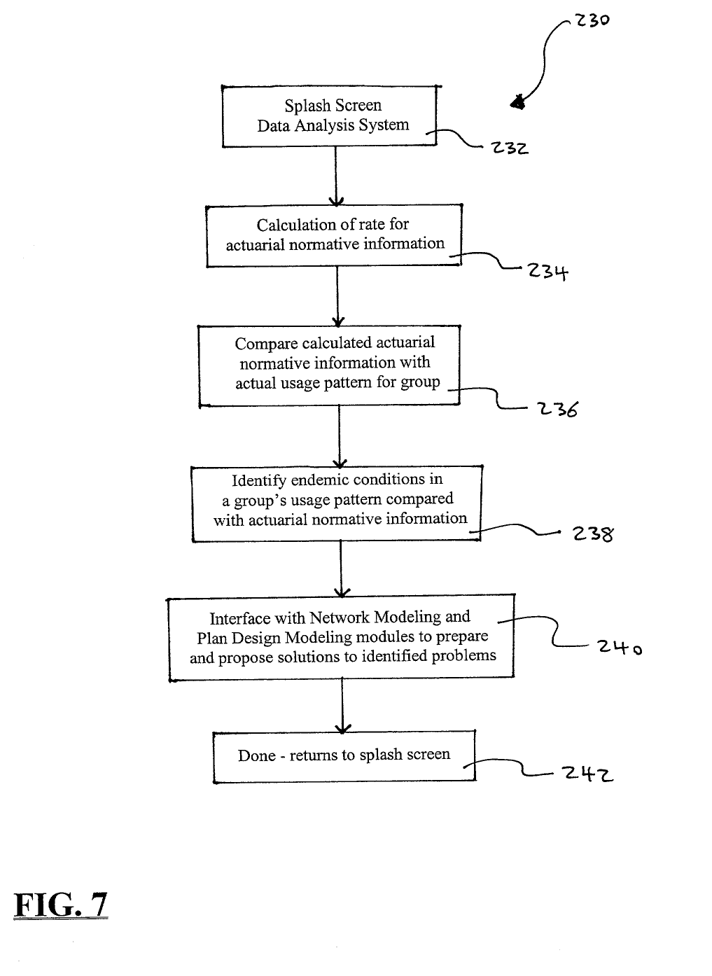

The computer program of the present invention also includes a Group Health Caims Analysis module 230. Referring to FIG. 7, module 230 compares information on how the group uses its benefits programs against actuarial normative information to determine if there is something endemic within the group's usage pattern or benefit configuration that shows up as highly abnormal. If an abnormal condition appears in the group's information or data then, through integration with the Plan Design Modeler Network Modeler modules, solutions can be modeled to address the aberration. For example, the examination of the usage pattern might show a higher frequency of chiropractic utilization then predicted by an examination of the actuarial norms. In this case, a user could examine the plan design to see if there is something about the plan design that promotes usage or behavior on the part of employees to use chiropractors. If that is the case, the user can model plan design changes designed to counteract the condition. Similarly, this module will also identify disease category aberrations. For example, an examination of claims might show a much higher frequency of circulatory disorders than predicted based on the actuarial normative information. In this case, a user could target specific solutions to counteract higher circulatory disease functions within the group. Some solutions might include smoking cessation, stress management, weight control, cholesterol control or other types of programs that may assist in counteracting the higher claims costs associated with the disease category.

After displaying a splash screen of general information for the user 232, the computer program of the present invention begins the examination by first determining the actuarial normative data 234. The present invention examines a group's specific information from a rating process, which is how insurance companies determine rates. The variables examined in determining an actuarial-based rate for a particular group include at least one of the following: the demographic mix of the group, the age-sex mix (in other words, the mix of single and family employees), the geographic area (because rates vary by geographic zip codes), industry factors (certain industries actuarially produce lower claims costs or higher claims costs than other groups), and also the particulars of the plan being rated. The determination may include an examination of one or more of these variables. A $100 deductible plan would produce higher rates than a $200 deductible plan, and the group's usage pattern of a $100 deductible plan will be different than the group's usage pattern on a $200 deductible plan. The method starts with a rate calculation process to determine actuarial normative information that breaks out the estimate of disease usage or norms within a particular group or adjusted by the group's particular demographic components, geographic areas and industry factors, as well as the claim cost components associated with the plan design. Most of the information or the actuarial normative information that is generated on a group is compared 236 to the actual usage pattern on an actuarial database of large numbers that is not refined specifically to geographic areas or industry factors. The computer program then determines if the group's usage pattern or benefit configuration appears endemic or highly abnormal 238. The computer program also proposes solutions to the highlighted aberrations through integration with the Network Modeling and Plan Design Modeling modules 240. The computer program then completes its task 242 and returns to the initial splash screen 232.

The following paper examples illustrate use of and/or instructions for using the present invention.

### EXAMPLE 1

Network Selection Process:

The specialties that have sub-specialties include those sub-specialty counts in their totals. For example, the specialty of Primary Care has sub-specialties of family practice, general practice and internist. The counts for the physicians with the specialties of one of these three subspecialties will be included in the count for Primary Care.

Based on the selection criteria entered, providers that meet the criteria will be selected using characteristics such as Provider State, Provider County, or Provider Zip Code.

The provider will be linked to a Network Provider Reference to get each network in which the provider participates.

Counts for each network and/or state will be reported.

### EXAMPLE 2

Network Selection by Group Usage Pattern for Groups of 100+ With Claim Records Output:

Select all claims associated with a selected Employer Identifier (“ID”) or division where the Paid and/or Rejection Date is within the selected date range and where the fields such as Inst. Network ID and Prof. Network ID are populated with a zero in both columns; these are considered to be non-network claims. This report will be based upon non-network claims.

Using a provider Tax ID on the claim, link to the associated provider to determine their network affiliations and develop a list of networks to be examined.

The imported claim information can be used to gather the Eligible amount.

Total the eligible amount for all claims in the network. This is defined by calculating the total of the eligible amount for each claim that has a provider that is associated with that network.

For each claim, compute the discount. This is defined as: Discount Amount=Eligible Amount−CPT Allowed OR if no CPT Allowed is in claim record then use this calculation:

Discount Amount=Eligible Amount*average discount percent for claim type for this provider type.

CPT Allowed is the amount paid by this network for the CPT. Look up to the CPT Allowed table by network using the CPT from the claim. If the CPT code is blank on the claim, then substitute CPT Allowed with the Average Discount Amount for the network. This is calculated as: 100−Medicare Discount Percent*Average Medicare Amount (CPT table, the average percentages not including those with no percentages listed).

Average discount percent is calculated by Provider Type=hospital and claim type (inpatient, outpatient, if unknown use total). This will reference the Hospital Percentage Discount table by provider.

Network Eligible Amount (for each claim)=CPT Allowed (if non-hospital provider type) OR

Eligible Amount−Discount Amount. This figure can also be defined as the scheduled payable amount from the claim record

For each network, sum the computed figures: Eligible Amount, Discount Amount, and Network Eligible Amount.

### EXAMPLE 3

Network Selection by Group Usage Pattern—Groups of 100+ With Claim Records Output:

Select all claims associated with a selected Employer ID or division where the Paid and/or Rejection Date is within the selected date range; these are considered to be non-network claims.

Using a provider Tax ID on the claim, link to an associated provider to determine their network affiliations and develop a list of networks to be examined.

Total the eligible amount for all claims in the network. This is defined by calculating the total of the eligible amount for each claim that has a provider that is associated with that network.

For each claim, compute the discount. This is defined as: Discount Amount=Eligible Amount−CPT Allowed OR if no CPT Allowed is in claim record then use this calculation:

Discount Amount=Eligible Amount*average discount percent for claim type for this provider type.

CPT Allowed is the amount paid by this network for the CPT. Look up to the CPT Allowed table by network using the CPT from the claim.

Average discount percent is by Provider Type=hospital and claim type (inpatient, outpatient, if unknown use total). This will reference the Hospital Percentage Discount table by provider.

Network Eligible Amount (for each claim)=CPT allowed (if non-hospital provider type) OR

Eligible Amount−Discount Amount. This figure can also be defined as the scheduled payable amount from the claim record

For each network, sum the computed figures: Eligible Amount, Discount Amount, and Network Eligible Amount.

### EXAMPLE 4

Network Selection by Group Usage Pattern—Groups of 100+ With Claim Records Output (Secondary Network Layering (Based on Primary Network Selection):

Select all claims associated with the selected employer ID or division where the Paid and/or Rejection Date is within the selected date range and where the fields Inst. Network ID and Prof. Network ID are populated with a zero in both columns; these are considered to be non-network claims.

Using a provider Tax ID on the claim, link to an associated provider to determine their network affiliations and develop a list of networks to be examined.

Total the eligible amount for all claims in the network. This is defined by calculating the total of the eligible amount for each claim that has a provider that is associated with that network.

For each claim, compute the discount. This is defined as:

Discount Amount=Eligible Amount−CPT Allowed OR if no CPT Allowed is in claim record then use this calculation:

Discount Amount=Eligible Amount*average discount percent for claim type for this provider type.

CPT Allowed is the amount paid by this network for the CPT. Look up to the CPT Allowed table by network using the CPT from the claim.

Average discount percent is by Provider Type=hospital and claim type (inpatient, outpatient, if unknown use total). This will reference the Hospital Percentage Discount table by provider.

Network Eligible Amount (for each claim)=CPT Allowed (if non-hospital provider type) OR

Eligible Amount—Discount Amount. This figure can also be defined as the scheduled payable amount from the claim record.

For each network, sum the computed figures: Eligible Amount, Discount Amount, and Payable Amount.

### EXAMPLE 5

Network Selection by Employee Survey—Groups of <100 Without Claim Records Output Primary Network Modeling:

User will have entered data to a table.

Also includes the ability to copy from a previous record. This is so that additional dependents or multiple providers for the same employee can be easily entered.

Available data will be provider last name, first name, city, state, and zip. User will do a lookup to the Provider table to obtain a Tax ID.

Available data will be hospital name, city, state, and zip. User will do a lookup to the Provider table to obtain the Tax ID.

Run the Network Selection Process for counts only using this data.

When the “Add New Dependent” button is pressed, all of the information on the screen remains except the Dependent information which clears out.

When the user will presses the “Add Provider TIN” button to add more provider TINs, new records are added in the table for that dependent.

### EXAMPLE 6

Network Selection by Employee Survey—Groups of <100 Without Claim Records Output Secondary Network Modeling (Based on Primary Network Selection):

Use the data from Primary Network Modeling for Network Selection by Employee Survey process but exclude all records for any provider attached to the top network from Primary Network Modeling for Network Selection by Employee Survey output.

Run the process for counts only using this data.

### EXAMPLE 7

Network Disruption Analysis:

The idea is to display claimants that would be disrupted if the employer changed networks. This is defined as the new network and does not include the claimant's provider on its list of in-network providers. For example, claimant uses provider 10. That provider has network 100 and 101. The top network turns out to be Network 104, so claimant would be displaced if the employer changed to network 104. So this claimant should show up on this report because its provider is not in Network 104.

Show disrupted claimants individually regardless if employee was disrupted or not.

Sort the data by employee then dependent.

Produce a report for each of the requested networks individually.

### EXAMPLE 8

Network Sales Output:

The purpose is to produce a competitive ranking of networks for both hospital discounts (average discount percent rankings) and professional discounts (percent of Medicare fee scheduling ranking).

Work on each network separately.

The data that is used to pull information is the data that is pulled for the Network Analysis report. Only network providers are used in the calculations.

For hospitals, Allowed Amount=Eligible Amount−(Eligible Amount*Discount Percentage). The Discount Percent is based on the claim type, for instance, Inpatient, Outpatient or as the default, Total.

For Hospital Claims, Total the Allowed Amount columns and the Eligible Amount column. The Average Discount used for the ranking is computed as 1−(Allowed Amount/Eligible Amount)

For professional claims, use only Network providers for each network and get the CPT code for each claim. Select the network's fee schedule for a particular CPT code to obtain the network Allowed Amount. Compute Network Allowed Amount/Medicare Fee Schedule for the same CPT code. Compute the average of all claims for Network claims. For example:

| | | |
|---|---|---|
| Claim 1 - 100.00 Allowed Amounts | 75 Medicare | 133.333% |
| Claim 2 - 50.00 | 40.00 | 125.000% |
| Claim 3 - 1,000 | 987.5 | 101.270% |
| Total | | 359.600% |
| Average for Ranking | | 119.870% |

Compute Differential Percentage =Network total Allowed Amount divided by Medicare Total Allowed Amount. Show the percent out 2 decimal places.

Sort lowest Differential Percentage first for providers.

Sort highest Differential Percentage first for hospitals.

### EXAMPLE 9

Network Sales Output:

Purpose is to produce a competitive ranking of networks for both hospital discounts (average discount percent rankings) and professional discounts (percent of Medicare fee scheduling ranking).

Work on each network separately.

The data that is used to pull information is the data that is pulled for the Network Analysis report. Only network providers are used in the calculations.

For hospitals, Allowed Amount=Eligible Amount−(Eligible Amount*Discount Percentage). The Discount Percentage is based on the claim type, for instance Inpatient, Outpatient or as the default, Total.

For Hospital Claims, Total the Allowed Amount columns and the Eligible Amount column. The Average Discount used for the ranking is computed as 1−(Allowed Amount/Eligible Amount)

For professional claims, use only Network providers for each network and get the CPT code for each claim. Select the network's fee schedule for a particular CPT code to obtain the network Allowed Amount. Compute Network Allowed Amount/Medicare Fee Schedule for the same CPT code. Compute the average of all claims for Network claims. For instance:

| | | |
|---|---|---|
| Claim 1 - 100.00 Allowed Amounts | 75 Medicare | 133.333% |
| Claim 2 - 50.00 | 40.00 | 125.000% |
| Claim 3 - 1,000 | 987.5 | 101.270% |
| Total | | 359.600% |
| Average for Ranking | | 119.870% |

Compare the Allowed Amount for a network to the Allowed Amount for Medicare.

Compute Differential Percentage=Network total Allowed Amount divided by Medicare total Allowed Amount. Show the percent out 2 decimal places.

Sort CPT code ranges.

### EXAMPLE 10

### Specialty Output—Renewal Action Exhibit Report:

Claims data is entered into columns labeled for example Medical, Dental, Vision, Short Term Disability (“STD”), Long Term Disability (“LTD”), Life, and Total. All of the processing may be done per column except for the “Total column” which should be calculated per row. Each cell in the Total column is the sum of the numbers in the row.

The calculations may not take into consideration the percent signs. The division by 100 will give the correct percent amount. The percent sign can be used for screen viewing only.

The calculation is conducted as follows:

Incurred Claims=Paid Claims+Adjusted (+/−) from Network Changes+Adjusted (+/−) from Benefit Changes+Adjusted (+/−) from Reserve Changes+Discretionary Undetermined Adjustments (+/−)

Credible Incurred Claims=(Experience Credibility Factor*Incurred Claims)+((1−Experience Credibility Factor)*Standard Claims)

Applicable Trend Factor=(Months of Trend*Monthly Trend)

Projected Incurred Claims=((Applicable Trend Factor/100)+1)*Credible Incurred Claims

Projected Premium Needed =Projected Incurred Claims+Retention

Rate Adjustment Factor=(Projected Premium Needed/Premium at Current Rates)*100

Totals are each row's total and are usually shown on the right edge of the screen. The totals for the factor cells are averages only of the columns with factors in the row.

### EXAMPLE 11

Specialty Output—Present Plan & Alternative Plan Design Report:

The calculations in this section do not take into consideration the percent signs. The division by 100 will give the correct percent amount. The percent sign may be for screen viewing only.

Renewal Rates=(Rate Adjustment Factor*Present Rate for Type (Medical, Dental, Vision, STD, LTD, Life) for single and for family plans)/100

Alternative Plan Designs Rates=(Corresponding Rate Adjustment Factor*Present Rate for Type (Medical, Dental, Vision, STD, LTD, Life) for single and for family plans)/100

When the customer enters information into the Specialty Output Renewal Action Exhibit report screen and the Rate Adjustment Factors are figured out, the Rate Structure Selection screen will open up.

The customer will select which type of rate structures they wish to calculate selected from options such as Fully Insured or Self Insured. If self-insured is selected, the customer has the option to select to use Administration Rate Structures. If Administrative Rate Structures is selected, a screen opens up presenting options to make selections related to the insurance plan. The options may be divided into categories of benefit types such as Medical, Dental and Vision. The options may include composite rate, per covered person rate, employee only, employee plus spouse, employee plus dependants, children, and various combinations and variations of these options.

The customer will be allowed to make as many selections on this screen as necessary. If the customer selects items in the Medical section of the screen, then they can model the Dental and the Vision after those selections. When a customer makes their selections, those selections' abbreviations are passed to the Present Plan and Alternative Plan Design Report—Renewal Rate Summary Screen where they are displayed as row headers for the given rate amounts for the named plan types. Information from this screen is generally not saved. This screen may also be used by certain reports to display only certain types of information.

If the customer does not select to use the Administrative Rate structures another screen will open up showing rate structures for self insured. The options may be divided in categories such as annual fees, premiums, rates, prescription fees, and attachment levels.

This particular screen allows the user to select different types of Self Insured Rate structures to display on the Present Plan and Alternative Plan Design Report.

The customer will be allowed to make as many selections on this screen as necessary. When a customer makes their selections, those selections' abbreviations are passed to the Present Plan and Alternative Plan Design Report—Renewal Rate Summary Screen where they are displayed as row headers for the given rate amounts for the named plan types. Information from this screen is generally not saved. This screen may also be used by certain reports to display only certain types of information

If the customer chooses the Fully Insured Rate Structures another screen is displayed. That screen's functionality is explained in the example below.

### EXAMPLE 12

Rate Structures (Fully Insured):

The Rate Structures screen is used to determine which rate structures for the different lines of business (“LOB”) that are displayed on particular screens. The rate structures are for the fully insured plans.

When a customer makes their selections, those selections' abbreviations are passed to the Present Plan and Alternative Plan Design Report—Renewal Rate Summary Screen where they are displayed as row headers for the given rate amounts for the named plan types. Information from this screen is generally not saved. This screen may also be used by certain reports to display only certain types of information.

At the top of the Dental and Vision columns, there may be a radio button. This radio button fills in the column for the respective LOB with the same checks as the Medical section. The default for the radio buttons is de-selected. Once the user selects the radio buttons, the column's entries are put in. This saves the user time but if the user wants all but one or a few, then they can deselect the one(s) that they don't want, and the radio button becomes deselected, but the other checks in the column remain. If the user wants to select all of the same as Medical but more in addition, the user can select the radio button and add more to it with the radio button becoming de-selected.

Other entry fields on the screen are used to calculate the amount of dollars would be paid per the given amount. For example: for Short Term Disability (“STD”) the plan pays X amount of dollars for every ten dollars spent; for Long Term Disability (“LTD”) the plan pays X amount of dollars for every 100 dollars benefited; for Life the plan pays X amount of dollars for every 1000 dollars of coverage. These amounts are stored temporarily and then used for calculations for the output on the screen and or on the printed reports.

There are coming into existence today various PPO networks for dental and vision and other lines of business. Therefore all of the above modules and examples can be applied to dental, vision, disability, worker's compensation or other types of benefit networks which are usually offered by employers.

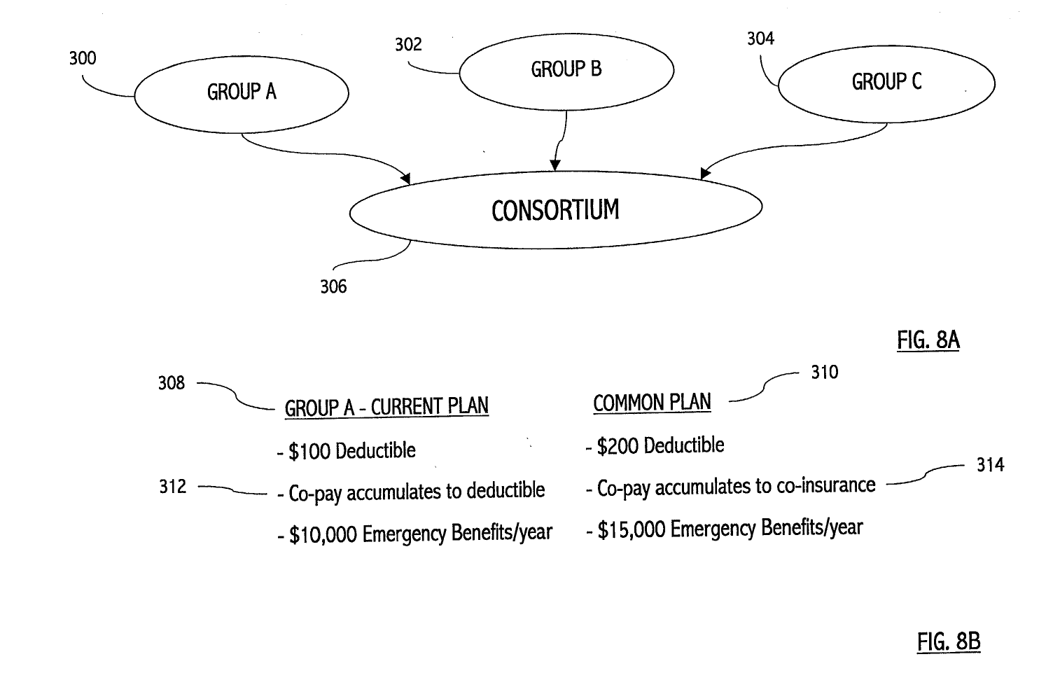

The plan design modeling capacity described above can also be used for additional types of group configurations. One such configuration is consortiums. An example of a consortium is shown in FIG. 8A. Basically, a consortium 306 is a number of employer groups 300-304 of a similar type. The claims data of a number of different groups can be linked together to perform plan design modeling. In this example, Group A 300, Group B 302 and Group C 304 combine their claims data to form a consortium 306. Thus, in this example, the plan design modeling becomes an actuarial modeling tool. This allows the user, in an automated fashion, to link together the claim records of multiple groups to determine a number of different factors. For instance, different employers or groups of employers may want to pool their business together for economic reasons. For example, schools in the state of Ohio, like to group themselves together by geographic territories and in effect pool their business together to create economies of scale. Economies of scale refers to a scaled reduction in fixed cost items such as administrative expenses, based on the size of the business. For example, if there are three school groups, each might have $500,000 in insurance premiums and have 15% in administrative costs. When these groups are put together, the administrative costs can be reduced to 12% for instance because the combined premium is $1.5 million and one group is being handled rather than three.

The problem with this particular approach is that each individual school has a different plan design and the consortium must somehow come up with actuarial rates to charge each particular school depending upon the “richness” of the benefit design. However, the design must also still take into consideration the pooling effect of the multiple schools claim data and the quality such as the degree of severity of each school's claim's experience. This could be done using the old methodology by using adjustment factors for various plan design differences based upon a actuarial model, or by use of the plan design modeler discussed above and as shown in FIG. 8B. For example, Group A 300, Group B 302 and Group C 304 may want to come up with a common plan design. A common plan design 310 can be developed that is agreeable to all three groups. The modeling program can take Group A's 300 in force plan configuration 308 and as shown in FIG. 8B, put in a common plan design 310 that all groups want to have in the model. For instance, Group A's current plan 308 may have features 312 such as a $100 deductible, a co-pay that accumulates to the deductible and $10,000 in emergency benefits per year. The common plan design will have some variations on these features 314 such as a $200 deductible, a co-pay that accumulates to the co-insurance and $15,000 in emergency benefits per year. Once the data is put into the plan design modeler, the program adjusts Group A's current plan's 312 claims data to what the claims would be under the common plan 314. The same thing can be done for all of the groups so that a proper price for a particular base plan design is determined. From that base plan design, variations such as different deductibles or different co-insurance values can be modeled so that each school is aware of the rates they should charge depending upon their particular plan configuration.

The advantage of this approach is to get the pooling effect of the claims data for all the different schools in the consortium to serve the needs of the entire group. In this way, the experience of just one group does not substantially impact the claims cost or the rates charged for a particular group.

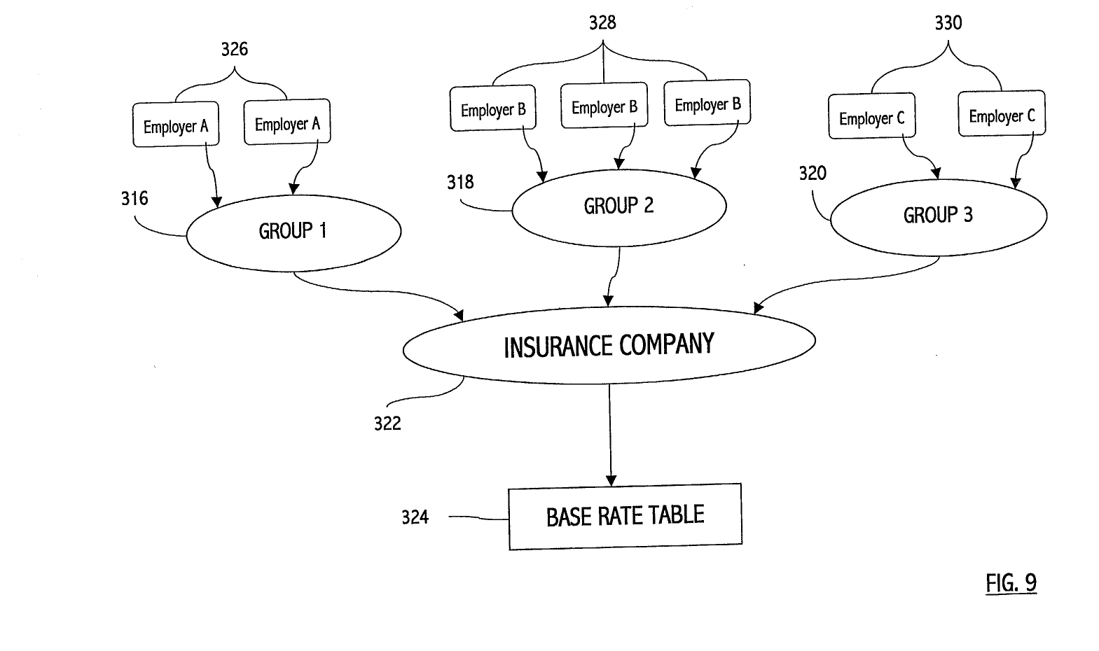

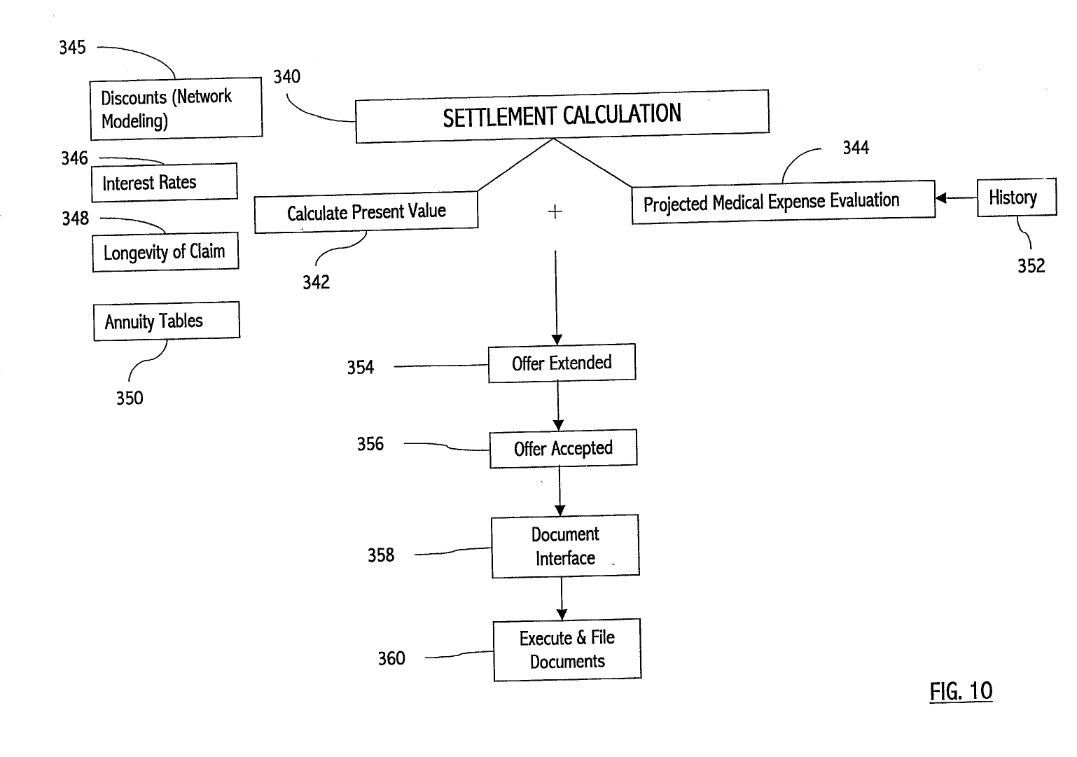

Insurance companies can use a similar approach to determine base rate tables for their pooled groups as shown in FIG. 9. For example, an insurance company can take all of their employer groups between one employee and 99 employees represented by 326, 328, 330, and pool all of their claim data to determine the base rate tables 324 that should be charged. Since the insurance company has many different basic plan designs that they allow the employer groups to select from, a methodology has to be employed to determine what the base rate tables should be. The plan design modeler with the consortium groups as described above can be used to accomplish this task. For example, an insurance company may have 500 groups all with different plan designs in a pool between 1 to 99 large. All of these 500 groups can be grouped together by different industry classifications as shown by 326, 328 and 330. Employers of type A 326 can be grouped 316 together, Employers of type B 328 can be grouped together 318 and Employers of type C 330 can be grouped 320 together. The type of group may be based on a variety of factors including but not limited to size, corporate structure, line of business or other characteristics. The insurance company 322 will then take each group 316, 318, and 320 and model them to a basic plan design. For example, the basic plan design may include a $100 deductible, or a 90%/80% Preferred Provider Organization (“PPO”) plan. Then the program can recalculate the claims cost to change from that $100 deductible plan to a $200 or $300 deductible plan or a 90%/70% PPO plan design and so on. Thus, the pool of actual claim statistics can be used in a modeling fashion in the insurance company 322 to determine the base rate tables 324 that the insurance company should charge. This is a more accurate methodology than the actuarial statistics used today to develop pooled rates.

The next module deals with Worker's Compensation Analysis. A first piece of the Worker's Compensation Analysis is a module for network modeling as it relates to worker's compensation claims. In the same fashion as in the health insurance network modeling described above, the actual discounts that an employer is receiving on his worker's compensation claims from his current MCOs and comparing those with the discounts that would be available from other MCOs on the same claim information. In this way, the best match of doctors and hospitals that the currently disabled employees utilize and the best discounts on those claim costs can be determined.

A second feature to be incorporated into the worker's compensation area is shown in FIG. 10. This module includes a settlement calculation 340 with a document interface 358. This works as follows. At some point in the lifecycle of the claim, the worker's compensation claim must be settled. This action releases reserves from the employer's books or from the Bureau's of Worker's Compensation Liability for which the employer is charged. The reserves are a projected amount of future payable liability. Employers include this liability in accounting records as a payable item. When a claim is settled, the reserves are released to a cash payment of the claim with any surplus returning to usable capital for the employer.

In the settlement calculation, the value of the settlement offer needs to be calculated from both the employer and the employee perspective. This process is automated in the present invention. In addition, a present value 342 of the claim in the settlement calculation can be included based upon the deepest discounts 345 found in the network modeling area. The present value 342 of the claim costs will be computed at various interest rates 346 which will be projected forward based upon the longevity of the claim 348 and annuity tables 350 which calculate the employees' life expectations. The interest rate calculation can be varied to reach a more conservative or more optimistic amount of the settlement. In summary, the settlement calculation 340 module of the invention calculates the present value 342 of a worker's compensation claim. This process includes inputting or importing data into the present value calculation feature 342 of the program. The data includes but may not be limited to discounts 345 found in network modeling, interest rates information 346, information about the longevity of the claim 348, and annuity tables 350 used to calculate an employee's life expectancy.

The settlement calculation feature can be divided into two areas. One is a disability calculation which is a rather straightforward present value calculation 342 as described above. The present value of the disability calculation 342 is combined with a projected medical expense evaluation 344. The more difficult portion is determining what the projected medical expenses 344 will be on the employee for inclusion in the settlement calculation. This projected medical expense value is based upon the employee's current and past history 352 in the medical expense arena. Once a settlement calculation is derived, an offer is made 354 to the parties, namely the employer and employee, for the parties to accept or reject. If the offer is accepted by the parties 356, a document interface 358 will produce the settlement documents. These documents will then be executed and then filed with the appropriate parties 360. The parties include the Bureau of Worker's Compensation, the courts, if appropriate, as well as plaintiff and defense counsel.

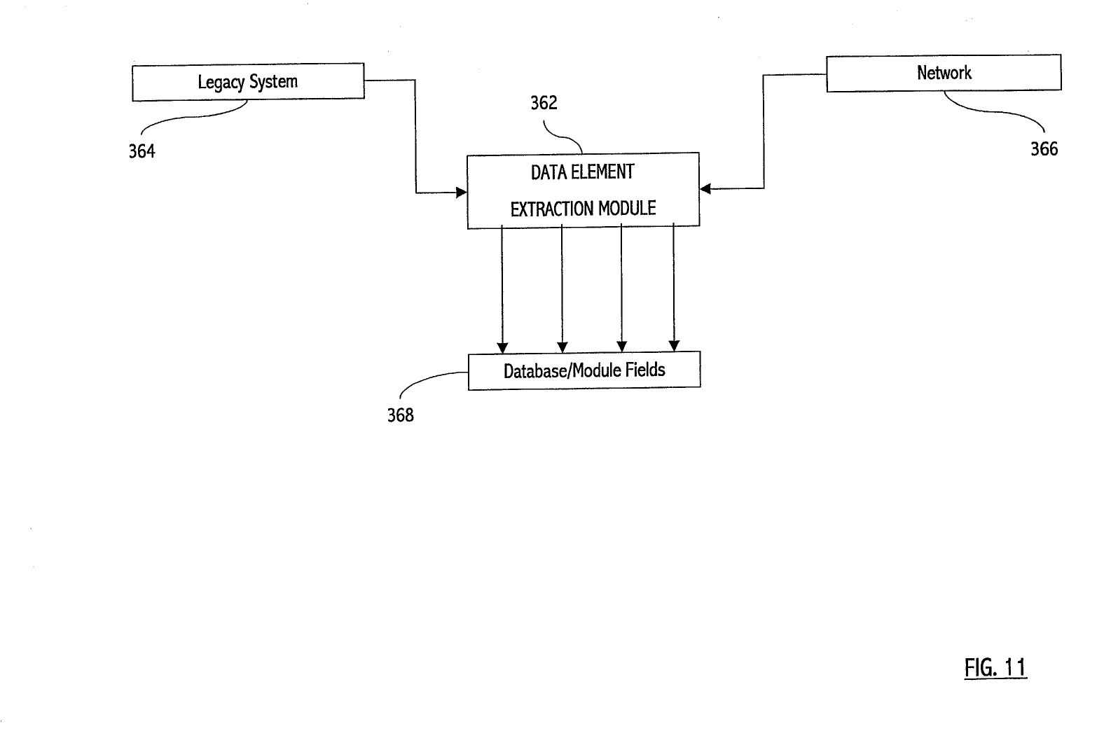

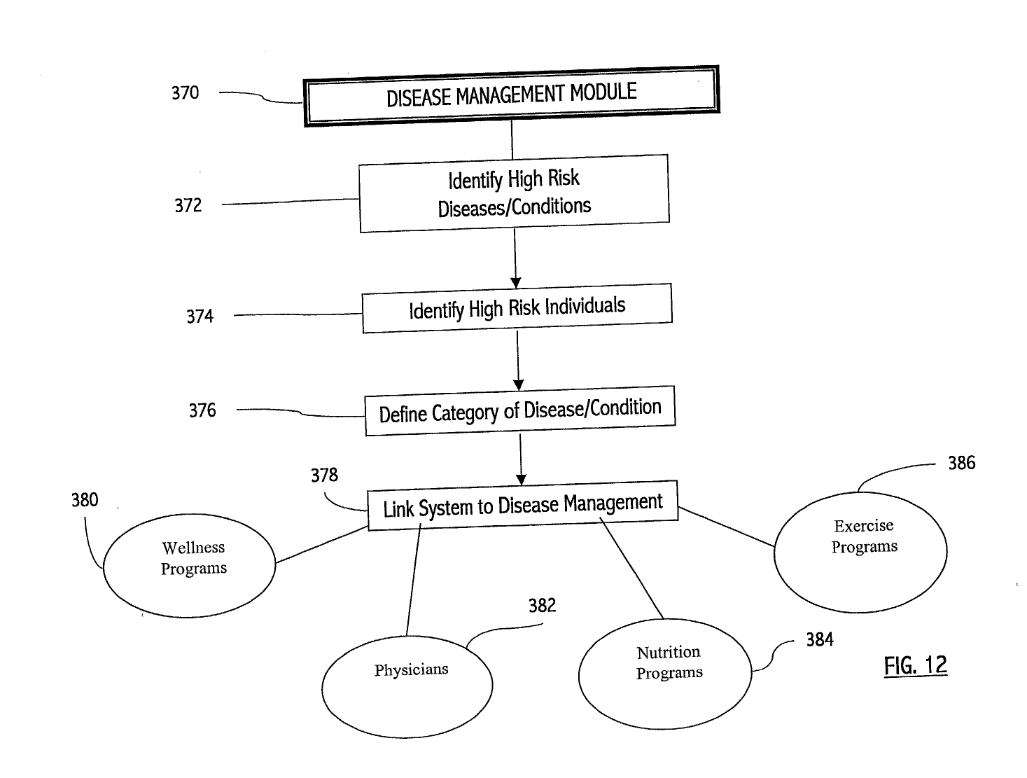

Another module is related to data element extraction and is shown in FIG. 11. This will be a tool that a customer uses to link with an internal legacy system 364, such as a mainframe, or a local area network 366. This tool will then extract the data elements 362 that the provider company's or an employer's various applications 368 require from the customers data processing systems. The data is then inserted into fields in a database 368 of the system of the present invention. For example, if an insurance company has 300 employer groups to run in a given month, this will allow a volume extraction of data elements from the legacy system to be inserted into the present system's database. The process will thus enhance the speed of the delivery of the running of the applications discussed herein by the users in part by substantially eliminating the need to input all the data information prior to running a calculation. This also decreases the chances for human error in inputting data into the calculation modules.

The next module relates to a disease management program 370. This feature may be integrated with the findings of an actual versus normative comparisons by ICD9 categories module. ICD9 is an acronym for International Classification of Diseases, 9^{th} Edition. The actual versus normative comparison identifies various high risk or over utilized diseases 372 within a particular employer group. The comparison can also be used to identify high risk individuals 374 in the group. A category 376 is also defined for the type of disease or condition in question. For example, if an employer has higher than expected normal usage of cardiac claims cost or cancer claims cost, these would be the categories. In these modules, specific cancers or heart conditions that the group is encountering will be identified, as well as the individuals who are incurring these higher claims costs. This information is integrated with the disease management programs 378 by category.

The disease management programs comprise a series of tools or interactions associated with various modules of the current system described herein. It should be understood that such programs can be built within a suite of products owned such as those described herein or linked with a specialty company that handles certain disease management programs. These programs may include and are certainly not limited to wellness programs 380, physicians 382, nutrition programs 384 and exercise programs 386. For example, with cardiac care, a series of wellness type programs may be used to handle the disease, if for example higher cholesterol values are identified within the group. This is because the higher cholesterol is likely contributing to the increased cardiac claim costs. Thus, a service can be provided that works in conjunction with the individual's physicians to lower the cholesterol values of the group. As another example, in the case of diabetic disease management, the program can be linked with nutrition programs or glucose screening programs or other types of wellness activities in conjunction with the physician to lower and help manage the disease. This can be done with any type of diseases that are identified within the employer group. This will have an overall positive impact upon the claims values within the employer group.

The next feature that can be incorporated into the present system is an automated request for a quotation process. A problem identified in the industry at this particular stage, is that brokers or consultants normally request quotations and send out requests for quotations to insurance carriers. This information is presented to an underwriter who evaluates the information and presents a proposal back to the broker or the consultant. Most of the time, the information presented is incomplete such that it leaves questions in the mind of the underwriter. When this happens, the underwriter may adopt a more conservative stance in a proposal than would otherwise be taken if information was properly presented. Thus, it is advantageous to provide a tool which allows complete and properly formatted information to be assembled such that the underwriter could readily access and produce the quotation. The present system contemplates incorporating data elements representing for instance, all of the claims information, the disease categories, the eligibility files, and the provider information for a number of years on an employer. Thus, it will be fairly simple to produce output reports in a fashion that would substantially meet the needs of the underwriter. If the data is presented to the underwriter in a clean fashion along with discount information which is not normally provided to the underwriter, the party requesting the quotation is more likely to receive the best possible bids on the insurance coverage. In addition to formatting the reports and the information correctly in the request for proposal process, the party requesting the quotation can select standardized questions or questionnaires to present along with the quotation to the various bidding parties. This information will go out in a standard package and the information coming back to the present system will be in a standardized format. The information will also be in a format that all of the parties can utilize. It is contemplated by the present invention that the information can be in a single format usable by all parties. Alternatively, this module can allow the parties to take the information and format it to meet their needs. With either format, the parties will know that all of the necessary information has been submitted. For instance, the forms for entering information may have indicators of what information must be provided for processing of the form. There may additionally or alternatively be warning or error messages given if necessary information is omitted. This automated request for proposal module allows participants to be able to present the proposals in a form that can be readily evaluated by the requesting party, the broker, the underwriter and any other parties involved in the process. This is advantageous for allowing the best proposals to be selected for a presentation to the customer.

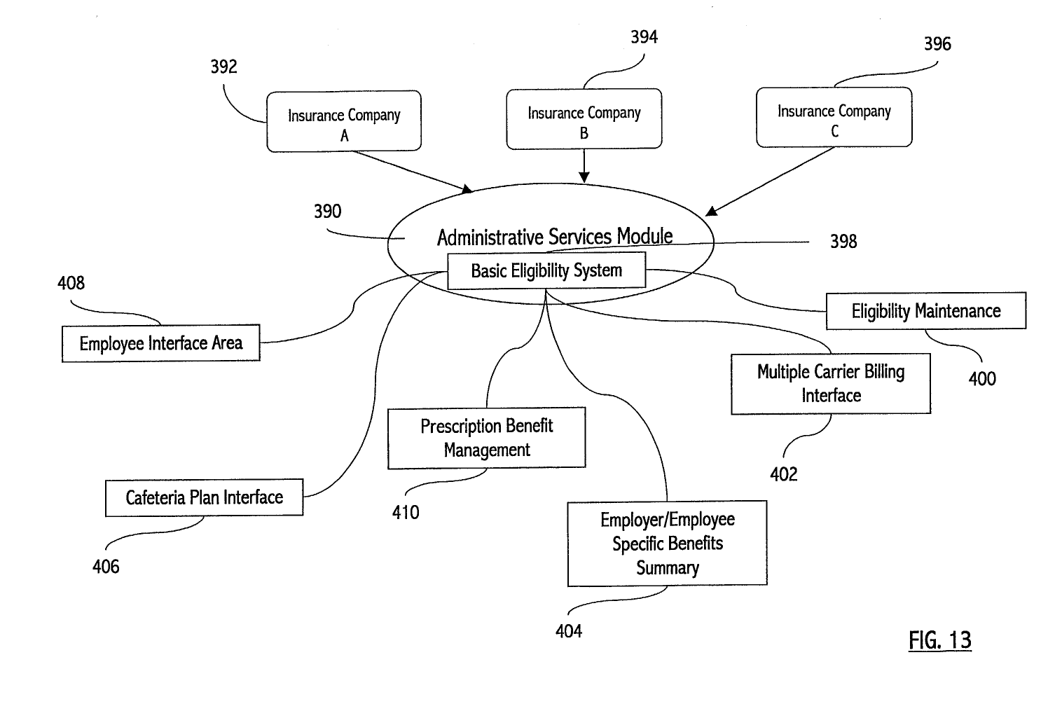

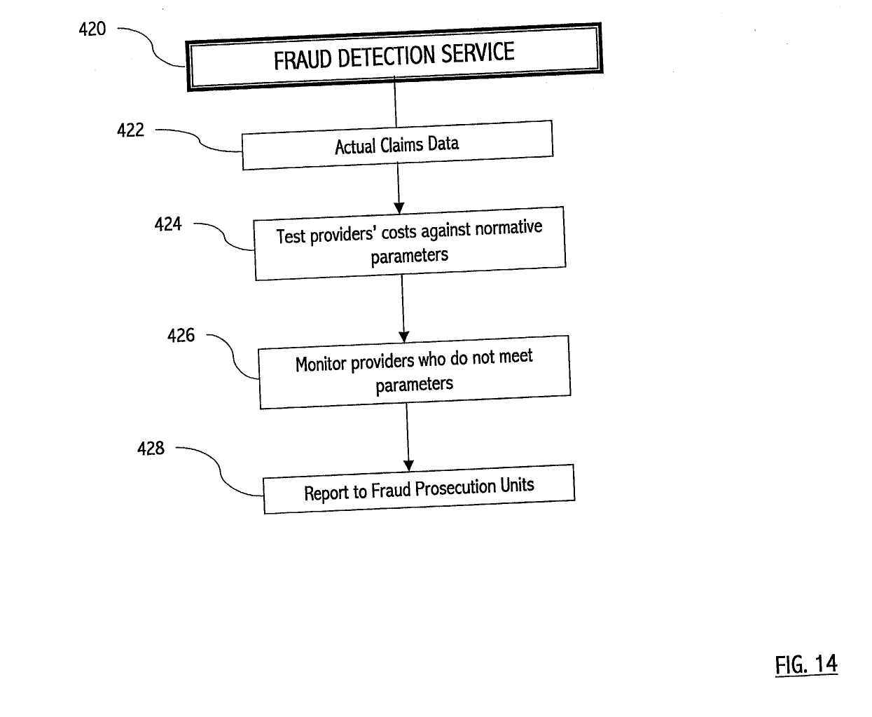

The next module is an administrative services module 390 as shown in FIG. 13. A problem that is commonly faced by employer groups today is that the employer may have many different insurance carriers or vendors who handle different components of the employer's benefit package. For example, insurance company A 392 might have the health insurance, while insurance company B 394 has the dental insurance and insurance carrier C 396 has the vision insurance. In prior art methods, when the human resources (“HR”) department processes a new employee or terminates an employee, it has to complete multiple forms so that employees will be properly enrolled or terminated. This is to comply with of various federal and state regulations regarding continuation of coverage, i.e. COBRA or HIPPA. This becomes an extremely complex process. The employer many times will overlook enrolling an employee or terminating an employee from a particular line of business in a timely fashion thus incurring difficulties such as additional paperwork, problems for the employee, or increased costs.

The present computer program product or system contemplates carrying or having available through it's basic systems 398 most of the information that would be utilized to enroll or delete employees. Thus, it would be advantageous to produce an administrative services module to interface with the various insurance vendors 392-396. For example, the initial modules or sub modules of the administrative services will include an multiple carrier billing interface 402 and an eligibility maintenance area 400 so that new employees will be added and deleted properly. This can also interface with services including but not limited to COBRA and HIPPA, should those be subcontracted elsewhere.

The basic piece of the administrative services module 390 is the basic eligibility system 398. The basic eligibility system 398 has a listing of all of the employees including but not limited to the name of the employees, dates of birth, dates of hire, occupation, salary, what benefits they have, whether they have single or family coverage, whether or not the spouse and/or children are enrolled, and all the information on the dependents, where applicable. This information flows into a multiple carrier billing system 402 as well as into an eligibility maintenance file 406. This can be printed out on a various frequency basis or updated electronically by the HR department or the employees directly. Thus, when a new employee starts, he or she will complete some basic data electronically in the eligibility maintenance file 400 which will then flow into the multiple carrier billing area 402 through the administrative services module.

Should the employee need information about networks or forms etc., there will be an employee interface area 408 which comprises a section having the various insurance carriers' forms. For example, if a claim form is needed for dental insurance it can be downloaded electronically from the employee interface area 408. If an employee needs to certify the student status of one of the employee's children, the appropriate form can be downloaded and executed by the school and transmitted back to the various insurance carrier. Should the employee need information about the various PPO networks, there will be a network interface piece so that an employee specific PPO directory can be downloaded or the employee will be able to look up providers directly on the PPO networks website.

Another feature that will be handled here in the administrative services area is an employer/employee specific benefits summary 404. The administrative service module 390 will have the capabilities of providing summary information about the various insurance programs of the employer. If for example, the employer has three different medical programs, the medical programs specific to the employee will be accessed once the employee data is entered into the system. This is so that an employee can look up what benefits are payable for a specific medical procedure. For instance, an employee can call up the information about their specific insurance program and see the highlights of the benefits right on line. This will be interfaced with all of the benefits available to the employee whether it's medical, dental, vision, long term or short term disability, life insurance, any voluntary programs, employee assistance plans, etc. This may also be interfaced with the employers 401 K plan or pension and profit sharing program. In this way, the employee can access through this summary page all of the information related to that employee specific benefit program. If the employer has made available certain financial planning tools, for the pension and profit sharing program, this will also be interfaced so that the employee can access this area through this section of the website, database or system of the present invention.

Another feature that will be available through this administrative services is a section 125 or a cafeteria plan interface 406. If an employer makes available benefit programs either through a pretax contribution or has various other accounts available through a section 125 program, the employee will be able to access the information specific to the employee's accounts through this section of the website, database or system. For example, an employee may have selected through the section 125 program to defer $2,000.00 into the employee's health care account. This may also be referred to as a flexible spending account. From this area of the website, database or another type of shared system, the employee will be able to track the submission of employee claims, see the reimbursement status of those health care claims through the health care account, and to determine what dollars remain in the health care account. If the employer has established a full cafeteria menu such that the employee can elect options such as having health plan A, or dental program C, the election capabilities and the tracking of what elections have been made can be handled through this section of the administrative services area. This can be evolved into a full enrollment process to be handled on an annual basis which will then interface with the employee eligibility maintenance area 400 and also be tied back into the multiple carrier billing system through the administrative services module.

The next module is referred to herein as prescription benefit management (“PBM”) services 410. PBM services operate today as a coordination link between the parties that actually discount the prescription drug costs and have built the pharmacy network. The PBM services handle the processing of employee eligibility data to the provider of the claims services. Many times, third party administrators or other specialized companies perform the PBM functions. The present system will be able to handle these through subcontracting the structuring of a PBM network, specifically the network of retail pharmacies and the discounts associated with it. This will be handled by the subcontractor. The present system's administrative systems and eligibility information will be directly interfaced with the subcontractors. In this way, the information that is handled either through the administrative services module or through the basic eligibility system, will interface with the subcontractor who will process the claims. Many of the third party administrators or the complete PBM management services do not fully pass along discounts and rebates to customers in currently used systems. The present invention will provide a position to pass along greater savings to the employer since it already has the eligibility information and the administrative services through the administrative services module. This allows the present invention to process electronically the data for the claims administrator.

The next feature is a prescription benefit management 410 audit service. This section is also tied into the administrative services module. The basic system in the plan design modeler captures all of the claim elements on each individual claim record associated with the prescription drug claims. This will allow the system to incorporate into the audit functions the details of the specific contract between the employer and the pharmacy benefit management company. There are advantages to using the present audit process. The prior art methodology is to take a sampling of the claim records to test the accuracy of the discounting provided by the pharmacy benefit management company and to test the amount of the rebates that are given back to the employer. The present system will be much more accurate in that it will provide a calculation based upon each and every prescription claim to test these features. Not only will it test the discount and the rebate but it will also double check the dispensing fee and the administrative fees that the pharmacy benefit management company is charging to the employer. This will provide the capability to have an automated system which can produce a more accurate audit of the pharmacy costs at a much lower expenditure on the part of the employer for the audit functions than is available through the current services.

The next feature deals with PBM Coordination of Benefits (“COB”) and Collection services. One problem faced by the industry today is the cost of the continued use of Prescription Cards by employees who continue to use the cards after their employment has been terminated. In addition, many times, employer groups do not notify their present insurance company of their intent to terminate coverage on the entire group as required by contract, such as thirty days in advance of the intended termination date. Instead, these employers allow the termination to take effect at the end of the premium payment grace period, for instance, thirty days after the due date of the premium. While some employer groups notify an insurance company of termination of benefits, others just allow the non payment of premium to cause the employee's or employer group's coverage to be terminated by the insurance company. Due to this process, many employees in the group are able to continue to use the Prescription Cards to refill prescriptions after the termination date of the employer group. Insurance companies lose millions of dollars monthly due to this problem and they are struggling to find ways to cut off the improper use of Prescription cards in these circumstances. Some Insurance Companies are implementing various aggressive collection procedures against former customers or other means to stem these loses—all of which are can be considered Non-Customer friendly. Another problem that the Insurance companies have in existing systems is that PBM functions are many times handled outside of the Insurance Company. In addition, PBMs don't usually offer normal insurance company type COB claims handling functions.

A better, more consumer friendly method is by using the benefit management modules of the present invention as illustrated in FIG. 15. This method will utilize the existing contractual language, determine what new insurance company properly should have provided the Prescription Card benefit, submit the improperly paid claims to the new carrier and receive reimbursement of these claims from the new carrier.

A prescription benefit management, coordination of benefits and collection process is illustrated in FIG. 15. The module 440 of the present invention will take in data from the present system regarding the eligibility information and prescription claim records 442 from various insurance companies and employers. The use of this module will integrate the employee/employer eligibility data and the Prescription Claim records as represented by 442 to produce this collection process from the new insurance company who should have properly paid for these claims. The module 440 uses the eligibility information to determine the employer's or employee's new insurance carrier and benefit coverage 444. The module can assist or handle the submission of claims 446 to the new insurance company 443 who should have paid the claim. The new insurance company 443 can then reimburse 448 the old insurance company 441 for the amount of the claim paid. This procedure allows for an expeditious handling of improperly paid claims without resorting to potentially unfriendly communications from the insurance companies to customers.

In addition, if the benefits under the new insurance company do not cover as much of the claim as the old benefits, this module may also include a feature capable of producing and/or sending a statement to the employer or employee who benefited from the improper submission. This will allow the “old” insurance companies to recoup most, if not all, of the money lost on such improperly submitted claims.

The next feature deals with employee benefit statements. This is fundamentally a communication piece that employers can utilize to provide individual employee statements of the cost of the benefit programs that an employee has and the value of the benefits that the employees have. These communication pieces may be produced by outside sources and funnel back to the employees. The system of the present invention captures all of the data elements already in it's other modules and through some massaging of the data and some calculations produces a comprehensive employee benefit statement. Some of the data elements used in this process are the cost of the medical program or dental program or all of the programs that the employer is paying, which is an element that is included on the employee benefit statement. Through integration with the 401 K and the pension and profit sharing module, the value of the contributions that the employers are making to the pension and profit sharing program and the employee contributions are also known. Through the interface with the 401 K vendor the present system can take the information on investment performance that the employee has received through the past year and project that forward through a standardized current growth rate assumption. This allows the employee to see the value of his or her retirement program. The inclusion of social security as part of the retirement package is also a fairly standardized projection based upon the wages of the employees. This can also be captured in the underlying information that comes from the administrative services module or through the eligibility features from the data that is extracted from the employer's system. This information will enable the production of a comprehensive annual employee communication piece which provides information regarding the benefits which employee has available through the corporation at a much lower cost than the employer would be able to purchase from a single specialized vendor.

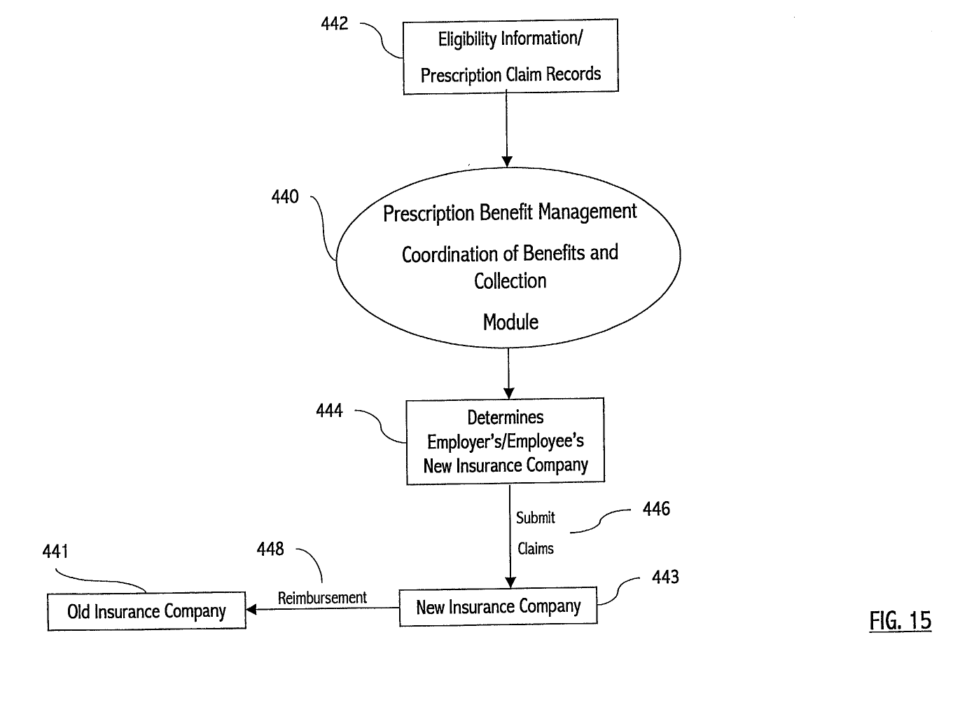

The next feature is a fraud detection service which is illustrated by the flow chart in FIG. 14. This will be able to analyze actual claims data 422 including health, dental, vision, prescription, or other types of claims. The claims data are tested against normative parameters such as codes and billing practices of providers, doctors, hospitals, dentists or laboratories. The data is tested against algorithms to determine whether the volume of billing of certain procedures fits within the normative parameters. Should they not fit within normative parameters according to the algorithms, these providers will be flagged 426 for further monitoring and eventual submission of the information to a fraud prosecution unit 428. This may be done through the underlying insurance carrier or through the various state and/or federal agencies. The information about the specific claim detail which is obtained can then be provided to the fraud prosecution units so that they can further evaluate and/or prosecute any potential fraud or abuse by a provider.

Another feature is an automated billing module. All of the modules of the present invention may require payment of various subscription fees on a annual and/or renewal basis. In the present system, these fees or other fees such as transaction costs can be automatically produced. For example, in the plan design modeling feature, a certain dollar amount will be billed per employee for three plan design comparisons or for use of three modules. Once the employer or the user decides to use more than 3 he falls into another billing category where the dollar amount per employee is billed again possibly at a discounted rate. The above example should not be construed to limit the billing function of the present invention to any particular number of designs or modules. Customers may be able to pay a flat fee for unlimited access to all modules or may also be charged per transactions.

The billing module will automate the billing functions so that the proper transaction fees and/or subscription fees will be emailed to the finance department of the various users. Other methods of communication may also be used. For instance, the billing module may be set up to automatically print out bills on a predetermined time schedule. The bills once printed could be mailed or faxed to customers. Further, the bills could be automatically faxed to users by the present billing module. The system can also be set up to make automatic withdraws from a users bank account. If this is the case, the automatic billing function will, for instance, inform the user that a certain amount will be draw from the users bank account by a ACH transfer automatically three days later or five days later depending upon what the frequency is and the amount of the invoice. This feature will improve the accuracy of billing procedures. In addition, payments on a bank to bank automatic clearing house transfer in a very timely fashion, thus increasing the timeliness of payment and settlement of debts between the customer and the service provider.

The foregoing disclosure is illustrative of the present invention and is not to be construed as limiting thereof. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention as defined in the claims. Within the claims, means-plus-function language is intended to cover the structures described in the present application as performing the recited function, and not only structural equivalents but also equivalent structures. The written description and drawings illustrate the present invention and are not to be construed as limited to the specific embodiments disclosed. Modifications to the disclosed embodiments, as well as other embodiments, are included within the scope of the claims. The present invention is defined by the following claims, including equivalents thereof.

What is claimed is:

1. A computerized method of managing employee benefits, comprising the steps of:
receiving employee benefit data for an insurance plan;
receiving employee data;
accepting desired modifications to said employee benefit data and/or said employee data;
storing said employee benefit data and/or said employee data;
dividing said employee benefit data and/or said employee data into categories;
formatting said employee benefit data and/or said employee data; and
displaying said formatted data.

2. The method as recited in claim 1 wherein said employee benefit categories are one or more members selected from the group consisting of: workers compensation insurance, medical insurance, dental insurance, vision insurance, prescription drug benefits, profit sharing plans, pension plans, and 401 K plans.

3. The method as recited in claim 2 wherein said employee benefit data is divided into a worker's compensation insurance category and wherein said employee data comprises a worker's compensation claim by an employee.

4. The method as recited in claim 3 further comprising:
calculating a present settlement value for said worker's compensation claim; and
calculating projected medical expenses for said employee.

5. The method as recited in claim 4 further comprising:
providing an electronic worker's compensation settlement form for said worker's compensation claim.

6. The method as recited in claim 4 further comprising:
extracting desired portions of said stored employee benefit data and said stored employee data for use in other computerized applications.

7. The method as recited in claim 1 wherein said step of dividing said employee benefit data and/or said employee data into categories comprises:
defining categories of health conditions;
dividing said employee data according to medical claims due to said health conditions; and
determining the frequency of occurrence of medical claims in each health condition category.

8. The method as recited in claim 7 further comprising:
identifying employees at risk to file a medical claim based on one or more of said categorized health conditions; and
providing health care prevention services to said identified employees directed to said heath condition.

9. The method as recited in claim 1 wherein said step of accepting desired modifications to said employee benefit data and/or said employee data comprises:
accepting modifications to said employee data wherein said employee data is employee insurance plan enrollment data.

10. The method as recited in claim 9 wherein said modification comprises a change in said employee's prescription benefit provider from a first prescription benefit provider to a second prescription benefit provider.

11. The method as recited in claim 10 wherein said first prescription benefit provider pays a claim after said modification of said prescription benefit provider to said second prescription benefit provider, said method further comprising:
transmitting said modifications to said enrollment data to said prescription benefit providers; and
remitting payment by said second prescription benefit provider to said first prescription benefit provider.

12. The method as recited in claim 1 wherein said step of dividing said employee benefit data and/or said employee data into categories comprises:
dividing said employee benefit data and said employee data for each covered employee.

13. The method as recited in claim 12 wherein the step of formatting said employee benefit data and/or said employee data comprises:
summarizing said employee benefit data and/or said employee data for each covered employee.

14. An electronic system for managing employee benefits, said system comprising:
a computing device and display;
means for receiving data for an insurance plan;
means for modifying said data;
means for categorizing said data;
means for storing said data;
means for formatting said data;
means for displaying said formatted data; and
means for transmitting said data.

15. The system as recited in claim 14 further comprising:
means for extracting desired data from said system; and
means for transmitting said extracted data among modules of said system.

16. The system as recited in claim 14 further comprising:
means for tabulating data for claims submitted by employees; and
means for detecting anomalies caused by fraud in said claims data.

17. The system as recited in claim 14 wherein said means for modifying said data comprises:
means for modifying employee insurance plan enrollment data;
means for transmitting said modified insurance plan enrollment data to a employee benefit provider.

18. The system as recited in claim 14 wherein said insurance plan is worker's compensation insurance.

19. The system as recited in claim 18 further comprising:
means for calculating a present value of an employee's worker's compensation claim;
means for projecting an employee's employee benefit usage for a period of time; and
wherein said means for formatting said data comprises a means for preparing a settlement form for said employee's worker's compensation claim.

20. The system as recited in claim 14 wherein said means for formatting said data comprises:
means for extracting employee benefit data for a single employee; and
means for summarizing said employee benefit data for said single employee.

21. The system as recited in claim 14 further comprising:
means for allowing employees to access said insurance plan data; and
means for allowing employees to modify aspects of their insurance plan.

22. A computer program product for use with a data processing system for managing employee benefits, said computer program product comprising:
a computer usable medium having computer readable program code means embodied in said medium for receiving employee benefit data, said employee benefit data comprising one or more members selected from the group consisting of available insurance plan benefits, employee enrollment data, insurance plan benefit modifications, and insurance benefit claims by employees;
a computer usable medium having computer readable program code means embodied in said medium for receiving instructions for dividing said employee benefit data into categories; and
a computer usable medium having computer readable program code means embodied in said medium for extracting data having desired characteristics from said employee benefit data.
